(19) United States
(12) Patent Application Publication
(10) Pub. No.: US 2025/0171345 A1
(43) Pub. Date: May 29, 2025

(54) GLASS ARTICLES WITH INCREASED HYDROXYL GROUP UNIFORMITY COMPRISING STACK SEALED GLASS SUBSTRATES, AND METHODS OF FORMING THE SAME

(71) Applicant: CORNING INCORPORATED, CORNING, NY (US)

(72) Inventors: Michael John Campion, Corning, NY (US); Kenneth Edward Hrdina, Horseheads, NY (US); Pattarin Sillapachai McLaren, Corning, NY (US); David M. Tomford, Colton, NY (US)

(21) Appl. No.: 18/944,759

(22) Filed: Nov. 12, 2024

Related U.S. Application Data
(60) Provisional application No. 63/603,792, filed on Nov. 29, 2023.

(51) Int. Cl. C03B 23/00

(52) U.S. Cl. CPC C03B 23/006

(57) ABSTRACT

A method of forming a glass article includes positioning a first glass substrate and a second glass substrate with a first interface surface of the first glass substrate facing a second interface surface of the second glass substrate to produce a glass article precursor, and heating the glass article precursor in a sealing environment to stack seal the first glass substrate to the second glass substrate to form the glass article. Subsequent to the heating, the second interface surface and the first interface surface are in direct contact with one another, establishing an interface between the first glass substrate and the second glass substrate.

### CROSS REFERENCE TO RELATED APPLICATION

This application claims the benefit of priority under 35 U.S.C. § 119 of U.S. Provisional Application Ser. No. 63/603,792 filed on Nov. 29, 2023, the content of which is relied upon and incorporated herein by reference in its entirety.

### FIELD

The present specification generally relates to glass articles. More specifically, the present specification is directed glass articles that include two or more glass substrates stack sealed to each other, where the glass articles have increased hydroxyl group uniformity, and methods of forming the glass articles.

### BACKGROUND

Applications such as large lightweight mirrors for telescope applications as well as for large extreme ultraviolet (EUV) mirrors for low numerical aperture (NA) and high NA systems are desired. Extreme ultraviolet (EUV) lithography uses optics to illuminate, project, and reduce pattern images to form integrated circuit patterns. The optics for EUV lithography are currently made from low thermal expansion glass, such as silica-titania glass. Production of larger scale low thermal expansion glass is difficult but necessary for creating larger ultra-stable optics pieces for mirror applications. Present methods of forming glass articles may be limited by the size of glass articles formed therefrom based on limitations such as furnace size or technical limits of forming larger glass articles.

Larger EUV lithography systems and telescope systems may require larger mirrors. Furthermore, the glass in an EUV lithography system must be able to meet stringent uniformity and thermal expansion requirements in the system. Specifically, the glass must be able to maintain its surface shape (known as “figure”) when subject to temperature changes in the system. A temperature stable glass can help to avoid any induced distortions in the wavefront characteristics of EUV projection optics.

### SUMMARY

Therefore, an ongoing need exists for glass articles including two or more glass substrates stack sealed at an interface, where the glass articles have increased uniformity across the interface and methods of making such glass articles. Embodiments of the present disclosure provide a glass article comprising a first glass substrate and a second glass substrate stack sealed to the first glass substrate at an interface. The glass articles have improved hydroxyl group concentration uniformity across the interface. In embodiments, a peak-to-valley difference of a hydroxyl group concentration measured along a first line may be less than or equal to 30 ppm, wherein the first line is perpendicular to the interface and extends between a depth of the first glass substrate of a first distance from the interface and the interface. Embodiments of the present disclosure also provide methods of making the glass article to provide the improved hydroxyl group concentration uniformity. The improved hydroxyl group concentration uniformity of the glass article across the interface provides increased thermal stability to the glass article, thereby enabling the glass article to better maintain surface shape in response to temperature changes. In embodiments, the methods of forming the glass articles disclosed herein may include positioning a first glass substrate and a second glass substrate with a first interface surface of the first glass substrate facing a second interface surface of the second glass substrate to produce a glass article precursor, and heating the glass article precursor in a sealing environment at a sealing temperature and for a time sufficient to stack seal the first glass substrate to the second glass substrate to form the glass article. The result is a glass article having a more uniform distribution of hydroxyl group concentration across the interface.

According to a first aspect, a method of forming a glass article comprises: positioning a first glass substrate and a second glass substrate with a first interface surface of the first glass substrate facing a second interface surface of the second glass substrate to produce a glass article precursor, wherein the first interface surface and the second interface surface are spaced apart by a distance greater than or equal to 0 mm and less than or equal to 5 mm; heating the glass article precursor in a sealing environment at a sealing temperature and for a time sufficient to stack seal the first glass substrate to the second glass substrate to form the glass article; wherein: the sealing environment comprises steam, an inert gas, or combinations thereof; subsequent to the heating, the second interface surface of the second glass substrate and the first interface surface of the first glass substrate are in direct contact with one another, wherein the direct contact between the first glass substrate and the second glass substrate establish an interface between the first glass substrate and the second glass substrate; and a peak-to-valley difference of a hydroxyl group concentration measured along a first line is less than or equal to 30 ppm; wherein: the first line is perpendicular to the interface and extends between a depth of the first glass substrate of a first distance from the interface and the interface; and the hydroxyl group concentration is measured along the first line at a spacing of less than or equal to 0.1 mm.

According to another aspect, a method of forming a glass article comprises: positioning a first glass substrate and a second glass substrate with a first interface surface of the first glass substrate facing a second interface surface of the second glass substrate to produce a glass article precursor, wherein the first interface surface and the second interface surface are spaced apart by a distance greater than or equal to 0 mm and less than or equal to 5 mm; heating the glass article precursor in a sealing environment at a sealing temperature and for a time sufficient to stack seal the first glass substrate to the second glass substrate to form the glass article; wherein: the sealing environment comprises steam, an inert gas, or combinations thereof; subsequent to the heating, the second interface surface of the second glass substrate and the first interface surface of the first glass substrate are in direct contact with one another, wherein the direct contact between the first glass substrate and the second glass substrate establish an interface between the first glass substrate and the second glass substrate; and a birefringence of the glass article, as measured at the interface, is less than or equal to 50 nm/cm, less than or equal to 20 nm/cm, or less than or equal to 10 nm/cm.

According to another aspect, a glass article comprising a first glass substrate and a second glass substrate stack sealed to the first glass substrate at an interface, wherein: a peak-to-valley difference of a hydroxyl group concentration measured along a first line is less than or equal to 30 ppm; wherein: the first line is perpendicular to the interface and extends between a depth of the first glass substrate of a first distance from the interface and the interface; and the hydroxyl group concentration is measured along the first line at a spacing of less than or equal to 0.1 mm.

According to another aspect, a glass article comprising a first glass substrate and a second glass substrate stack sealed to the first glass substrate at an interface, wherein a birefringence of the glass article, as measured at the interface, is less than or equal to 50 nm/cm, less than or equal to 20 nm/cm, or less than or equal to 10 nm/cm.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the description, it is believed that the description will be better understood from the following specification when taken in conjunction with the accompanying drawings, wherein:

FIG. 1A schematically depicts a side view of an exemplary glass article precursor, according to embodiments disclosed herein;

FIG. 1B schematically depicts a top view of the exemplary glass article precursor of FIG. 1A, according to embodiments disclosed herein;

FIG. 2A schematically depicts an exemplary glass article, according to embodiments disclosed herein;

FIG. 2B schematically depicts a cross-section of the exemplary glass article of FIG. 2A, according to embodiments disclosed herein;

FIG. 3 is a plot of temperature (y-axis) as a function of time (x-axis) during heating using exemplary methods for forming the glass articles, according to embodiments disclosed herein;

FIG. 4 is a plot of hydroxyl group concentration (y-axis) as a function of distance (x-axis) in a glass article formed exemplary methods, according to embodiments disclosed herein;

FIG. 5 is a plot of titania concentration (y-axis) as a function of distance (x-axis) in a glass article formed by exemplary methods, according to embodiments disclosed herein;

FIG. 6 is a plot of hydroxyl group concentration (y-axis) as a function of distance (x-axis) in a glass article formed by exemplary methods, according to embodiments disclosed herein;

FIG. 7 is a plot of hydroxyl group concentration (y-axis) as a function of distance (x-axis) in an exemplary glass article formed by an exemplary method, according to embodiments disclosed herein;

FIG. 8 is a plot of equilibrium hydroxyl group concentration in a glass substrate (y-axis) as a function of partial pressure of water (x-axis) in an exemplary method, according to embodiments disclosed herein;

FIG. 9 is a plot of partial pressure of water (y-axis) as a function of temperature (x-axis) in an exemplary method, according to embodiments disclosed herein;

FIG. 10 is a plot of hydroxyl group concentration (y-axis) as a function of distance (x-axis) in an exemplary glass article formed by an exemplary method, according to embodiments disclosed herein;

FIG. 11 is a plot of hydroxyl group concentration (y-axis) as a function of distance (x-axis) in an exemplary glass article formed by an exemplary method, according to embodiments disclosed herein;

FIG. 12A is a plot of hydroxyl group concentration (y-axis) as a function of distance (x-axis) in a glass article, according to embodiments disclosed herein;

FIG. 12B is a plot of hydroxyl group concentration (y-axis) as a function of distance (x-axis) in an exemplary glass article, according to embodiments disclosed herein;

FIG. 12C is a plot of hydroxyl group concentration (y-axis) as a function of distance (x-axis) in a glass article, according to embodiments disclosed herein;

FIG. 12D is a plot of hydroxyl group concentration (y-axis) as a function of distance (x-axis) in a glass article, according to embodiments disclosed herein;

FIG. 13A is a plot of hydroxyl group concentration (y-axis) as a function of distance (x-axis) in a glass article, according to embodiments disclosed herein;

FIG. 13B is a plot of hydroxyl group concentration (y-axis) as a function of distance (x-axis) in an exemplary glass article, according to embodiments disclosed herein;

FIG. 13C is a plot of hydroxyl group concentration (y-axis) as a function of distance (x-axis) in a glass article, according to embodiments disclosed herein;

FIG. 13D is a plot of hydroxyl group concentration (y-axis) as a function of distance (x-axis) in a glass article, according to embodiments disclosed herein;

FIG. 14A is a plot of hydroxyl group concentration (y-axis) as a function of distance (x-axis) in a glass article, according to embodiments disclosed herein;

FIG. 14B is a plot of hydroxyl group concentration (y-axis) as a function of distance (x-axis) in a glass article, according to embodiments disclosed herein;

FIG. 14C is a plot of hydroxyl group concentration (y-axis) as a function of distance (x-axis) in an exemplary glass article, according to embodiments disclosed herein;

FIG. 14D is a plot of hydroxyl group concentration (y-axis) as a function of distance (x-axis) in a glass article, according to embodiments disclosed herein;

FIG. 15A is a plot of hydroxyl group concentration (y-axis) as a function of distance (x-axis) in a glass article, according to embodiments disclosed herein;

FIG. 15B is a plot of hydroxyl group concentration (y-axis) as a function of distance (x-axis) in a glass article, according to embodiments disclosed herein;

FIG. 15C is a plot of hydroxyl group concentration (y-axis) as a function of distance (x-axis) in a glass article, according to embodiments disclosed herein; and

FIG. 15D is a plot of hydroxyl group concentration (y-axis) as a function of distance (x-axis) in a glass article, according to embodiments disclosed herein.

### DETAILED DESCRIPTION

Reference will now be made in detail to embodiments of the glass articles and methods of making the glass articles, various embodiments of which will be described herein with specific reference to the accompanying drawings. Whenever possible, the same reference numerals will be used throughout the drawings to refer to the same or like parts. The present disclosure is directed to a glass article comprising a first glass substrate and a second glass substrate with improved hydroxyl group uniformity across an interface formed from joining the first glass substrate and the second glass substrate and methods of forming the glass article. Embodiments of the present disclosure provide glass articles with substantially uniform hydroxyl group concentrations across an interface between the first glass substrate and the second glass substrate. The present disclosure is also directed to methods of forming the glass article comprising the first glass substrate and the second glass substrate, the methods comprising positioning a first glass substrate and a second glass substrate with a first interface surface of the first glass substrate facing a second interface surface of the second glass substrate to produce a glass article precursor, and heating the glass article precursor in a sealing environment at a sealing temperature and for a time sufficient to stack seal the first glass substrate to the second glass substrate to form the glass article.

In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the disclosure. In addition, like or identical reference numerals may be used to identify common or similar elements. Moreover, unless otherwise defined, all technical and scientific terms used herein have the same meaning as commonly understood by one of ordinary skill in the art to which this disclosure belongs. In case of conflict, the present specification, including the definitions herein, will control.

Although other methods and materials can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or

F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an endpoint of a range, the disclosure should be understood to include the specific value or endpoint referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. For purposes of the present disclosure, the term “about” when used in reference to a numerical value means the numerical value is within a range defined by ±3 of the last decimal place of the numerical value. For example, the numerical value “about 10.0” means a value between 9.7 and 10.3.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass articles discussed herein, certain impurities or components that are not intentionally added, can be present in the final glass composition. Such materials are present in the glass composition in minor amounts and are referred to herein as “tramp materials.”

As used herein, a glass composition having 0 (zero) mole percent (mol %) or 0 weight percent (wt. %) of a compound is defined as meaning that the compound, molecule, or element was not purposefully added to the composition, but the composition may still comprise the compound, typically in tramp amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp amounts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include, in addition to single referents, plural referents unless the context clearly dictates otherwise. Thus, for example, reference to “a” component includes aspects having two or more such components, unless the context clearly indicates otherwise.

Directional terms as used herein—for example up, down, right, left, front, back, top, bottom, vertical, horizontal—are made only with reference to the figures as drawn and are not intended to imply absolute orientation unless otherwise expressly stated.

Large ultra-stable optics for mirror applications are needed for mirror applications. Some applications of such large ultra-stable optics include large light weight mirrors for telescope applications or for large EUV mirrors for low NA and high NA systems. However, conventional methods of forming glass articles may be limited by the size of glass articles formed therefrom based on limitations such as furnace size or technical limits of forming larger glass articles. Stack sealing may be used to join two or more glass substrates into a single large sealed glass article. However, conventional methods for joining the glass substrates may result in non-homogeneity of the glass article across an interface where the glass substrates are joined. For instance, conventional furnace conditions for stack sealing the glass substrates may include high temperatures, which may result in desorption of hydroxyl groups at the interface, which may reduce a concentration of hydroxyl groups at the interface relative to the hydroxyl group concentration of the glass substrates prior to the heating. Further, in situations in which the hydroxyl group concentration of the glass substrates is relatively low and a concentration of steam in the sealing environment is relatively high, the heating may result in adsorption of the hydroxyl groups at the interface, which may increase a concentration of hydroxyl groups at the interface relative to the hydroxyl group concentration of the glass substrates prior to the heating. A deviation of the hydroxyl group concentration at the interface of the glass substrates relative to the bulk glass substrates may induce temperature non-uniformity due to an increased coefficient of thermal expansion (CTE). This temperature non-uniformity may affect light waves incident on the interface of the two glass substrates, which may adversely affect the optical performance of the glass articles. Thus, it is desired that the glass articles formed from stack sealing two or more glass substrates may have improved hydroxyl group uniformity across the interface.

The embodiments of the present disclosure provide methods of forming a glass article comprising a first glass substrate and a second glass substrate stack sealed to the first glass substrate at an interface. The glass articles can be used as articles in various applications such as, but not limited to, mirrors for telescope systems or EUV systems. Specifically, embodiments of the present disclosure provide a glass article comprising a first glass substrate and a second glass substrate stack sealed to the first glass substrate at an interface. The glass articles may have improved hydroxyl group concentration uniformity at the interface, which may provide a glass substrate that can be easily polished while maintaining the overall low CTE value. The improved uniformity of the hydroxyl group concentrations at the interface may also improve the thermal stability of the glass articles. The methods disclosed herein can also be utilized to tune the concentration profile of the hydroxyl groups within the glass article.

A method of forming a glass article may comprise positioning a first glass substrate and a second glass substrate with a first interface surface of the first glass substrate facing a second interface surface of the second glass substrate to produce a glass article precursor and heating the glass article precursor in a sealing environment at a sealing temperature and for a time sufficient to stack seal the first glass substrate to the second glass substrate to form the glass article.

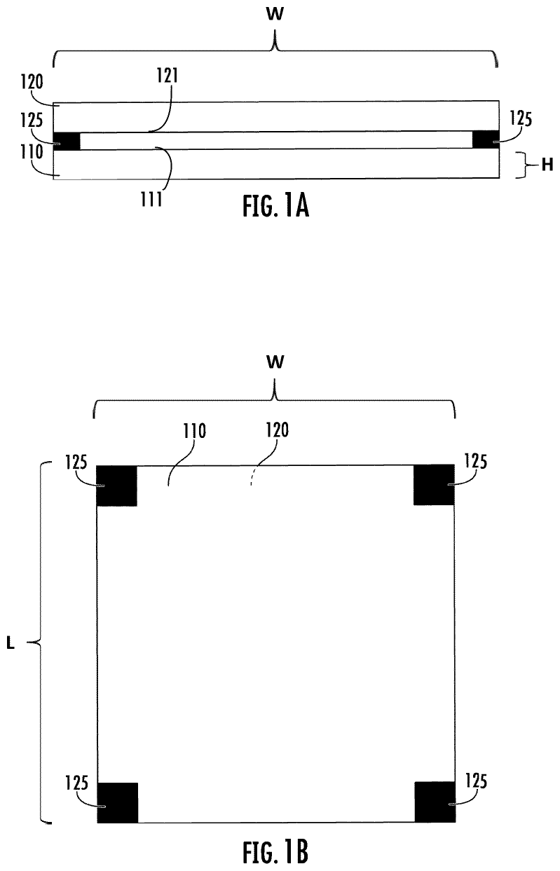

FIG. 1A shows a side view of a glass article precursor comprising a first glass substrate 110 and a second glass substrate 120. The first glass substrate 110 and the second glass substrate 120 may be positioned such that a first interface surface 111 of the first glass substrate 110 faces a second interface surface 121 of the second glass substrate 120. The first glass substrate 110 and the second glass substrate 120 may be separated by spacers 125, which may be operable to couple the first glass substrate 110 to the second glass substrate 120 while maintaining a void between the first glass substrate 110 and the second glass substrate 120 prior to stack sealing the first glass substrate 110 to the second glass substrate 120. In embodiments, the glass article precursor may not include the spacers 125 (not shown). FIG. 1B shows a top view of the glass article precursor shown in FIG. 1A.

In embodiments, the first interface surface 111 and the second interface surface 121 may be spaced apart by a distance greater than or equal to 0 mm and less than or equal to 5 mm. For instance, in embodiments, the first interface surface 111 and the second interface surface 121 may be spaced apart by a distance greater than 0 mm and less than or equal to 5 mm, greater than 0 mm and less than or equal to 4 mm, greater than 0 mm and less than or equal to 3 mm, or greater than 0 mm and less than or equal to 2 mm. In embodiments, the spacers 125 may have a thickness equal to the desired spacing between the first glass substrate 110 and the second glass substrate 120. The spacers 125 may comprise glass. For instance, in embodiments, the spacers 125 may have a thickness of from greater than 0 mm and less than or equal to 5 mm, greater than or equal to about 0.5 mm to less than or equal to about 1.5 mm, such as about 1.0 mm. Without intending to be bound by any particular theory, it is believed that the spacing between the first interface surface 111 and the second interface surface 121 may reduce an amount of gases trapped between the two glass substrates. Further, it is believed that a spacing between the first interface surface 111 and second interface surface 121 of greater than 5 mm may result in increased waste glass deposited at or near the spacers 125. In other embodiments, the first interface surface 111 and the second interface surface 121 may be in direct contact prior to the heating.

In embodiments, the glass substrates, such as the first glass substrate 110 and/or the second glass substrate 120 may comprise silica-based glass. The silica-based glass may be a titania-doped silica glass. In embodiments, first glass substrate 110 and/or the second glass substrate 120 may be produced from precursors, which may include but are not limited to octamethylcyclotetrasiloxane, titanium tetraisopropoxide, or combinations thereof. The first glass substrate 110 and/or the second glass substrate 120 may further comprise one or more additional modifiers and/or additives. In embodiments, the first glass substrate 110 and/or the second glass substrate 120 may have a weight of from greater than or equal to about 0.5 kilograms (kg), greater than or equal to about 5 kg, greater than or equal to about 10 kg, greater than or equal to about 12.5 kg, or greater than or equal to about 25 kg. In embodiments, the first glass substrate 110 and/or the second glass substrate 120 may have a weight of from less than or equal to about 10,000 kg, less than or equal to about 5,000 kg, less than or equal to about 1,000 kg, less than or equal to about 500 kg, or less than or equal to about 50 kg.

The first glass substrate 110 and/or the second glass substrate 120 may comprise a silica (SiO₂) concentration of greater than or equal to about 80.0 mole percent (mol. %), such as greater than or equal to about 85.0 mol. %, greater than or equal to about 90.0 mol. %, greater than or equal to about 92.0 mol. %, greater than or equal to about 95.0 mol. %, greater than or equal to about 98.0 mol. %, or greater than or equal to about 99.0 mol. % silica, based on the total moles of first glass substrate 110 and/or the second glass substrate 120. In embodiments, the first glass substrate 110 and/or the second glass substrate 120 may comprise a silica concentration of from about 85.0 mol. % to less than or equal to 100.0 mol. %, from about 87.0 mol. % to about 97.0 mol. %, from about 90.0 mol. % to about 95.0 mol. %, or from any and all ranges and sub-ranges between the foregoing values, based on the total moles of the first glass substrate 110 and/or the second glass substrate 120.

In embodiments, the first glass substrate 110 and/or the second glass substrate 120 may comprise titania (TiO₂). The first glass substrate 110 and/or the second glass substrate 120 may comprise a TiO₂ concentration of greater than or equal to 0.0 wt. % to less than or equal to about 15.0 wt. %, such as greater than or equal about 1.0 wt. % to less than or equal to about 14.0 wt. %, greater than or equal to about 2.0 wt. % to less than or equal to about 13.0 wt. %, greater than or equal to about 3.0 wt. % to less than or equal to about 12.0 wt. %, greater than or equal to about 4.0 wt. % to less than or equal to about 11.0 wt. %, greater than or equal to about 5.0 wt. % to less than or equal to about 10.0 wt. %, greater than or equal to about 6.0 wt. % to less than or equal to about 9.0 wt. %, greater than or equal to about 7.0 wt. % to less than or equal to less than or equal to about 8.0 wt. %, or any and all ranges and sub-ranges between the foregoing values, based on the total weight of the first glass substrate 110 and/or the second glass substrate 120.

The first glass substrate 110 and/or the second glass substrate 120 of the glass article precursor may each independently have a length (L), a width (W), and a height (H). In embodiments, each of the length (L) and the width (W) may be greater than the height (H). As used herein, height (H) and thickness may be used interchangeably unless explicitly stated otherwise. In embodiments, the length (L) and the width (W) may each be independently greater than or equal to about 15 cm, greater than or equal to about 25 cm, greater than or equal to about 50 cm, greater than or equal to about 75 cm, greater than or equal to about 100 cm, greater than or equal to about 150 cm, or greater than or equal to about 175 cm. In embodiments, the length (L) and the width (W) may each be independently less than or equal to about 200 cm. In embodiments, the first glass substrate 110 and/or the second glass substrate 120 of the glass article precursor may have a largest dimension greater than or equal to about 15 cm, greater than or equal to about 25 cm, greater than or equal to about 50 cm, greater than or equal to about 75 cm, greater than or equal to about 100 cm, greater than or equal to about 150 cm, or greater than or equal to about 175 cm.

Although FIG. 1B depicts the first glass substrate 110 and the second glass substrate 120 of the glass article precursor as having a square cross-sectional shape with flat surfaces, it is understood that the first glass substrate 110 and the second glass substrate 120 may have other shapes, such as but not limited to a cylindrical shape having a circular, elliptical, non-symmetrical or irregular cross-sectional shape. In embodiments, the first glass substrate 110 and/or the second glass substrate 120 can be curved, such as having a concave and/or convex structure or surface. In embodiments, the first glass substrate 110 and/or the second glass substrate 120 may have a radius (r) and a height (H). In embodiments, the radius (r) may be greater than or equal to one half of the height (H). In embodiments, the radius (r) may be greater than or equal to about 10 cm, greater than or equal to about 25 cm, greater than or equal to about 50 cm, or greater than or equal to about 75 cm. In embodiments, the radius (r) may be less than or equal to about 100 cm.

The height (H) of the first glass substrate 110 and/or the second glass substrate 120 may be less than each of the length (L) and the width (W), or less than two times the radius (r). In embodiments, the height (H) may be less than or equal to about 50 cm, such as less than or equal to about 40 cm, less than or equal to about 30 cm, less than or equal to about 20 cm, less than or equal to about 10 cm. Additionally or alternatively, in embodiments, the height (H) may be greater than or equal to about 10 mm, greater than or equal to about 25 mm, or greater than or equal to about 50 mm. In embodiments, an average height (H) of the first glass substrate 110 and/or the second glass substrate 120 may be determined by measuring the height (H) at a plurality or regions in the first glass substrate 110 and/or the second glass substrate 120. In embodiments, the first glass substrate 110 and/or the second glass substrate 120 may have an average height of greater than or equal to 10 mm, greater than or equal to 25 mm, or greater than or equal to 50 mm.

Although FIG. 1A depicts the first interface surface 111 and the second interface surface 121 of the glass article precursor as having flat surfaces, it is understood that the first interface surface 111 and the second interface surface 121 may be curved, such as having a concave and/or convex structure or surface. The shape of the first interface surface 111 may be complimentary to the contour of the second interface surface 121.

In embodiments, the glass article precursor may include three or more glass substrates which may be stack sealed to form a glass article comprising three or more glass substrates. In embodiments, a glass article formed from stack sealing two or more glass substrates may be subsequently stack sealed to one or more glass substrates and the method may be repeated any number of times. In other embodiments, a glass article may be formed from simultaneously stack sealing three or more glass substrates.

As described herein, the method of forming the glass article may include heating the glass article precursor comprising the first glass substrate 110 and the second glass substrate 120 in a sealing environment at a sealing temperature and for a time sufficient to stack seal the first glass substrate 110 to the second glass substrate 120 to form the glass article. As used herein, the term “stack seal” refers to sealing two or more separate glass substrates together to form a continuous single glass article. The term “stack sealed glass article” refers to a continuous single glass article formed from two or more separate glass substrates sealed to each other.

In embodiments, the glass article precursor may be positioned in the sealing environment prior to the heating. The sealing environment may be contained within a vessel operable to receive gases from one or more gas sources and/or water from a water source. In embodiments, the water may be treated in a first furnace to produce steam prior to introducing the steam to the sealing environment. The glass article precursor may be heated in the sealing environment to a sealing temperature operable to stack seal the first glass substrate 110 to the second glass substrate 120. For instance, in embodiments, the glass article precursor may be positioned in a furnace operable to receive gases from one or more gas sources and/or water from a water source. The furnace may be operable to be heated to the sealing temperature.

In embodiments, the heating may comprise maintaining the glass article precursor at a sealing temperature of greater than or equal to 500° C., greater than or equal to 800° C., greater than or equal to 1,000° C., greater than or equal to 1,200° C., greater than or equal to 1,400° C., greater than or equal to 1,600° C., greater than or equal to 1,800° C., or greater than or equal to 2,000° C. In embodiments, the heating may comprise maintaining the glass article precursor at a sealing temperature of less than or equal to 2,500° C., less than or equal to 2,200° C., less than or equal to 2,000° C., less than or equal to 1,800° C., less than or equal to 1,600° C., less than or equal to 1,400° C., or less than or equal to 1,200° C. In embodiments, the heating may include maintaining the glass article precursor at a sealing temperature of greater than or equal to about 1,600° C., or even greater than or equal to about 1,630° C. Without intending to be bound by any particular theory, it is believed that heating the glass article precursor at a temperature greater than or equal to 1,600° C., such as greater than or equal to about 1,630° C., may minimize devitrification during production of the glass article 100, thereby improving the quality of the glass article 100.

The heating may comprise exposing the glass article precursor to the sealing environment at the sealing temperature for a time sufficient to stack seal the first glass substrate to the second glass substrate. As used herein, the first glass substrate and the second glass substrate may be considered stack sealed once greater than 95% of the overlapping area of the first glass substrate and the second glass substrate are contacting. In embodiments, the time sufficient may be greater than or equal to 0.5 hour to less than or equal to 48 hours, such as from greater than or equal to 0.5 hours to less than or equal to 24 hours, greater than or equal to 1.0 hour to less than or equal to 18 hours, greater than or equal to 2.0 hours to less than or equal to 12 hours, greater than or equal to 3.0 hours to less than or equal to 6 hours, or any and all ranges and sub-ranges between the foregoing values.

In embodiments, the heating may comprise increasing a temperature of the glass article precursor to the sealing temperature at a temperature ramping rate for a first duration of time, maintaining the glass article precursor at the sealing temperature for a second duration of time, and decreasing the temperature of the glass article precursor at a cooling rate for a third duration of time. The sealing temperature may be increased at a temperature ramping rate of from 10° C. per hour to 1000° C. per hour during the first duration of time, such as at a temperature ramping rate of greater than or equal to 50° C. per hour to less than or equal to 500° C. per hour, greater than or equal to 100° C. per hour to less than or equal to 300° C. per hour, or about 250° C. per hour. In embodiments, after the second duration of time, the heating may comprise reducing the sealing temperature at a cooling rate of from 30° C. per hour to 1000° C. per hour for the third duration of time, such as at a cooling rate of from greater than or equal to 100° C. per hour to less than or equal to 500° C., greater than or equal to 200° C. per hour to less than or equal to 400° C., or about 300° C.

In embodiments, the heating may comprise increasing a temperature of the glass article precursor to a first hold temperature, maintaining the glass article precursor at the first hold temperature for a first hold time, increasing the temperature of the glass article precursor from the first hold temperature to the sealing temperature, maintaining the glass article precursor at the sealing temperature for a second hold time, and decreasing the temperature of the glass article precursor. In embodiments, the first hold temperature may be a temperature below the scaling temperature, such as greater than or equal to 400° C. to less than or equal to 1,200° C., such as about 1,000° C. In embodiments, the first hold time may be a duration of greater than or equal to 10 minutes to less than or equal to 5 hours, such as about 1 hour. In embodiments, the second hold time may be a duration of greater than or equal to 10 minutes to less than or equal to 5 hours, such as about 1 hour.

In embodiments, the heating may comprise exposing the glass article precursor to the sealing environment, wherein the sealing environment comprises steam; and laser treating the glass article precursor. As used herein, “laser treating” refers to localized heating of at least a portion of the glass article precursor using a laser. The laser treating may increase at least a portion of the first interface surface 111 of the first glass substrate and a portion of the and the second interface surface 121 of the second glass substrate to a temperature of greater than or equal to 1,400° C., greater than or equal to 1,600° C., greater than or equal to 1,800° C., or greater than or equal to 2,000° C. The laser treating may increase at least a portion of the first glass substrate and a portion of the second glass substrate to a temperature of less than or equal to 3,000° C., less than or equal to 2,800° C., less than or equal to 2,500° C., or less than or equal to 2,200° C. In embodiments, the laser treating may be operated for a time of greater than or equal to 1 millisecond to less than or equal to 20 seconds. For instance, in embodiments, the laser treating may be operated for a time of less than or equal to 10 seconds, less than or equal to 5 seconds, less than or equal to 3 seconds, less than or equal to 1 second, less than or equal to 50 milliseconds, less than or equal to 25 milliseconds, or less than or equal to 10 milliseconds. Without intending to be bound by any particular theory, it is believed that laser treating the glass article precursor may enable selective heating at the first interface of the first glass substrate 110 and the second interface surface 121 of the second glass substrate 120, which may reduce heating of the bulk glass material of the first glass substrate 110 and the second glass substrate 120. Further, it is believed that the laser treating may reduce the time needed to stack seal the first glass substrate 110 to the second glass substrate 120 compared to other methods disclosed herein such as heating in a furnace. The reduced heating time may reduce hydroxyl group diffusion at the interface, which may result in increased hydroxyl group uniformity in the glass article.

In embodiments, the sealing environment may comprise steam, an inert gas, or combinations thereof. The heating may comprise subjecting the glass article precursor to the scaling environment into which steam, an inert gas, or combinations thereof is introduced. In embodiments, the glass article precursor may be placed into a furnace providing the scaling environment. In embodiments, the partial pressure of the steam and/or the sealing temperature may be modulated to change desired properties of the glass article, such as but not limited to, the hydroxyl group concentration at the interface 130.

In embodiments, the heating may comprise introducing steam to the sealing environment to achieve a partial pressure of steam within the sealing environment of from greater than or equal to 0 kilopascals (kPa) to less than or equal to about 1,000 kPa, such as greater than or equal to 0.1 kPa to less than or equal to about 500 kPa, greater than or equal to about 1.0 kPa to less than or equal to about 400 kPa, greater than or equal to about 5.0 kPa to less than or equal to about 300 kPa, greater than or equal to about 10.0 kPa to less than or equal to about 200 kPa, or any and all ranges and sub-ranges between the foregoing values. In embodiments, the scaling environment may comprise greater than or equal to 0 volume percent (vol. %), greater than or equal to about 3.0 vol. %, greater than or equal to about 5.0 vol. %, greater than or equal to about 10.0 vol. %, greater than or equal to about 20.0 vol. %, greater than or equal to about 30.0 vol. %, greater than or equal to about 40.0 vol. %, greater than or equal to about 50.0 vol. %, greater than or equal to about 60.0 vol. %, greater than or equal to about 70.0 vol. %, greater than or equal to about 80.0 vol. %, greater than or equal to about 90.0 vol. %, greater than or equal to about 95.0 vol. %, greater than or equal to about 99.0 vol. %, or even 100 vol. % steam, based on a total volume of gases in the sealing environment. In embodiments, the sealing environment may comprise greater than or equal to 0 vol. %, greater than or equal to about 3.0 vol. %, greater than or equal to about 5.0 vol. %, greater than or equal to about 20.0 vol. %, greater than or equal to about 30.0 vol. %, greater than or equal to about 40.0 vol. %, greater than or equal to about 50.0 vol. %, greater than or equal to about 60.0 vol. %, greater than or equal to about 70.0 vol. %, greater than or equal to about 80.0 vol. %, greater than or equal to about 90.0 vol. %, greater than or equal to about 95.0 vol. %, or even 100 vol. % of inert gas, based on a total volume of gases in the scaling environment.

In embodiments, the method may comprise during heating maintaining a constant partial pressure of steam in the sealing environment and adjusting a temperature profile of the heating. In embodiments, the adjusting may maintain the absolute value of the difference of the hydroxyl group concentration at the interface and the hydroxyl group concentration at a depth of the first glass substrate of the first distance from the interface less than or equal to 30 ppm. The adjusting the temperature profile of the heating may comprise adjusting one or more of the sealing temperature, a temperature ramping rate, a duration of maintaining the glass article precursor at the sealing temperature, a cooling rate, or combinations of these. Without intending to be bound by any particular theory, it is believed that by increasing the sealing temperature while maintaining the partial pressure of steam in the sealing environment, the hydroxyl group concentration at the interface may be reduced relative to methods at a reduced sealing temperature. Further, it is believed that increasing the duration the glass article precursor is maintained at the sealing temperature may reduce the hydroxyl group concentration at the interface relative to methods having a shortened duration the glass article precursor is maintained at the sealing temperature. Without intending to be bound by any particular theory, it is believed that hydroxyl groups may diffuse into and out of the interface 130 while the interface 130 is open to the atmosphere of the sealing environment. Further, it is believed that once the interface 130 is sealed, variations in the hydroxyl group concentration at the interface 130 may inter-diffuse, which may decrease hydroxyl group concentration non-uniformity at the interface 130 when the glass article 100 is held at an increased temperature for an increased duration of time. Further, it is believed that slower heating rates and/or cooling rate may further decrease hydroxyl group concentration non-uniformity at the interface 130.

In embodiments, the method may comprise, during heating, adjusting a partial pressure of steam in the sealing environment to maintain the absolute value of the difference of the hydroxyl group concentration at the interface and the hydroxyl group concentration at a depth of the first glass substrate of the first distance from the interface less than or equal to 30 ppm. The adjusting the partial pressure of steam in the sealing environment may comprise increasing or decreasing a flow rate of steam, an inert gas, or both into the sealing environment. Without intending to be bound by any particular theory, it is believed that the partial pressure of steam in the sealing environment may be increased as the sealing temperature is increased and the partial pressure of steam in the sealing environment may be reduced as the sealing temperature is reduced to maintain high hydroxyl group concentration uniformity across the interface of the glass article.

In embodiments, a calculated partial pressure of steam during the heating may be determined as a function of the sealing temperature and the equilibrium hydroxyl group concentration of the bulk glass substrates. The partial pressure of steam in scaling environment and/or temperature of the sealing environment may be adjusted to achieve a desired hydroxyl group concentration at the interface. In embodiments, the partial pressure of steam during the heating is directly proportional to the equilibrium hydroxyl group concentration of the glass substrates. In embodiments, the square root of the partial pressure of steam during the heating is indirectly proportional to the exponential sealing temperature. This relationship between the partial pressure of steam, the concentration of the hydroxyl group concentration of the bulk glass substrate, and the sealing temperature is summarized, according to Equation 1 (EQU. 1).

$${P}_{H 2 O} = {[ {C}_{OH} [ ppm ] / A exp [ B / T ] ]}^{2} \qquad EQU . 1$$

In EQU. 1, C_{OH}[ppm] is C_{OH}[ppm] is the hydroxyl group concentration of the bulk glass substrate, p_{H2O} is the partial pressure of steam in atmospheres (ATM), T is the temperature of the scaling environment in degrees Kelvin, and A and B are integers. In embodiments, the C_{OH}[ppm] may refer to the hydroxyl group concentration of the first glass substrate 110 prior to the heating, or to the hydroxyl group concentration of the second glass substrate 120 prior to the heating.

Loss of hydroxyl groups may be influenced by the strength of association of hydroxyl groups to the first glass substrate 110 and the second glass substrate 120 of the glass article precursor. At high temperature, dissociation of hydroxyl groups from the first glass substrate 110 and the second glass substrate 120 may increase. This effect holds throughout the glass article precursor. Once dissociated, however, the hydroxyl groups may form water and the loss of hydroxyl groups is controlled by diffusion of the water to the outside surface of the first glass substrate 110 and the second glass substrate 120. Longer distances for diffusion are required for hydroxyl groups present in the inner portions of the first glass substrate 110 and the second glass substrate 120 than for the outer and peripheral portions of the first glass substrate 110 and the second glass substrate 120. Hydroxyl diffusion from inner portions of the first glass substrate 110 and the second glass substrate 120 may be inhibited relative to outer portions of the first glass substrate 110 and the second glass substrate 120 such as at the first interface surface 111 and the second interface surface 121. As a result, when heating the glass article precursor in a scaling environment having a relatively low concentration of steam compared to the hydroxyl group concentration of the bulk first glass substrate 110 and the second glass substrate 120, preferential loss of hydroxyl groups from the first interface surface 111 of the first glass substrate 110 and the second interface surface 121 of the second glass substrate 120 may occur. This effect may be compensated for or offset by the process of the present disclosure. By increasing a concentration of steam in the sealing environment relative to the hydroxyl group concentration of the bulk first glass substrate 110 and the second glass substrate 120 and/or relative to the scaling temperature, the hydroxyl group concentration at the interface of the resulting glass article may be tuned. Even though hydroxyl diffusion from the first interface surface 111 and the second interface surface 121 is favored relative to the bulk first glass substrate 110 and the bulk second glass substrate 120, the supply of an increased amount of steam in the sealing environment may result in hydroxyl group adsorption during the heating, which may provide a more uniform distribution of hydroxyl groups at the interface and at a depth of the first glass substrate of the first distance from the interface.

In embodiments, the sealing environment may further comprise oxygen. In embodiments, the scaling environment may comprise a partial pressure of oxygen of from greater than or equal to 1.0 kPa to less than or equal to 100 kPa. Without intending to be bound by any particle theory, it is believed that inclusion of oxygen in the sealing environment may minimize ablation and non-uniformity of the glass article formed from the heating. Further, it is believed that inclusion of oxygen in the sealing environment may reduce vaporization during the heating, such as the heating comprising laser treating. During the heating, the following reaction(s) may occur: SiO₂→SiO+½O₂ and/or TiO₂→TiO+½O₂. As SiO has a relatively high vapor pressure, SiO may leave the system. An increased partial pressure of oxygen in the scaling environment may reduce these reactions, which may in part maintain the stoichiometry and Si/Ti ratio, thereby minimizing non-uniformity in the glass article.

In embodiments, subsequent to the heating, the second interface surface 121 of the second glass substrate 120 and the first interface surface 111 of the first glass substrate 110 may be in direct contact with one another. The direct contact between the first glass substrate 110 and the second glass substrate 120 may establish an interface between the first glass substrate 110 and the second glass substrate 120. Without intending to be bound by any particular theory, it is believed that during the heating, a center portion of the first interface surface 111 may begin to contact a center portion of the second interface surface 121. Upon further heating, peripheral portions of the first interface surface 111 and the second interface surface 121 may contact each other. The glass article may include the first glass substrate 110 and fused to the second glass substrate 120. As the glass article is formed from two distinct glass substrates, the glass article have a difference of one or more properties between the first glass substrate 110 and the second glass substrate 120. For instance, the glass article may have an inflection point in hydroxyl group concentration, titania concentration, CTE slope, expansivity slope, birefringence, or combinations thereof. Such an inflection point may also distinguish the glass article from a bulk glass that is not formed from fusing two distinct glass substrates together.

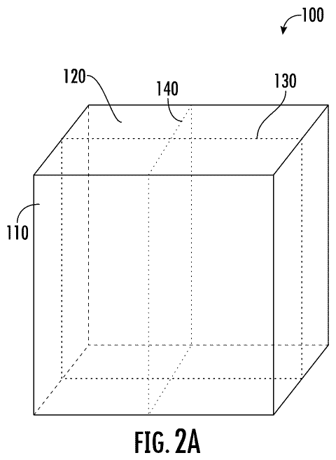

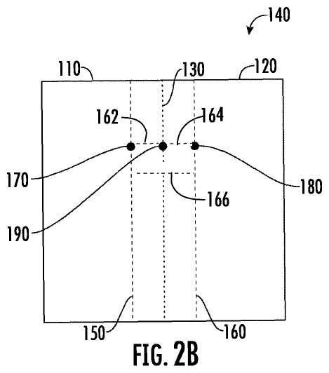

Referring now to FIG. 2A, the glass article 100 is schematically depicted having the first glass substrate 110 and the second glass substrate 120 in direct contact at an interface 130. A cross-section 140 of the glass article 100 perpendicular to the interface 130 is depicted.

Referring now to FIG. 2B, the cross-section 140 of FIG. 2A is depicted in further detail. As shown in FIG. 2B, the cross-section 140 includes the first glass substrate 110, the second glass substrate 120, and the interface 130 between the first glass substrate 110 and the second glass substrate 120. First trace 150 is also provided depicting a portion of the first glass substrate 110 positioned a first distance from the interface 130. Similarly, second trace 160 is provided depicting a portion of the second glass substrate 120 positioned a second distance from the interface 130. In embodiments, the first distance and/or the second distance may be about 5.0 mm, about 4.0 mm, about 3.0 mm, about 2.0 mm, or about 1.0 mm. In embodiments, the first distance and/or the second distance may be less than or equal to about 5.0 mm, less than or equal to about 4.0 mm, less than or equal to about 3.0 mm, less than or equal to about 2.0 mm, or less than or equal to about 1.0 mm. In embodiments, the first distance and/or the second distance may be greater than or equal to about 1.0 mm, greater than or equal to about 2.0 mm, or greater than or equal to about 3.0 mm.

The glass article 100 may be characterized to determine the hydroxyl group concentration uniformity, titania concentration uniformity, CTE slope uniformity, expansivity slope uniformity, and/or birefringence uniformity at the first glass substrate 110 and the interface 130, at the second glass substrate 120 and the interface 130, and/or at the first glass substrate 110 and the second glass substrate 120. For instance, one or more of the hydroxyl group concentration, the titania concentration, the CTE slope, the expansivity slope, and/or the birefringence may be measured along a line trace 162, a line trace 164, and/or a line trace 166. In embodiments, the line trace 162, the line trace 164, and/or the line trace 166 may be independent varied for each property measured. For instance, the line trace 162 may have a first position and a first length used to measure the hydroxyl group concentration, and the line trace 162 may have a second position and a second length used to measure the titania concentration. In other embodiments, one or more of the hydroxyl group concentration, the titania concentration, the CTE slope, the expansivity slope, and/or the birefringence may be measured at the same line trace 162, the line trace 164, and/or the line trace 166. The line trace 162 is perpendicular to the interface 130, and extends between the first trace 150 and the interface 130. The line trace 164 is perpendicular to the interface 130, and extends between the second trace 160 and the interface 130. The line trace 166 is perpendicular to the interface 130, and extends between the first trace 150 and the second trace 160. In embodiments one or more of the hydroxyl group concentration, the titania concentration, the CTE slope, the expansivity slope, and/or the birefringence may be measured at a first point 170, where the first point 170 is a portion of the first glass substrate 110 positioned at the first distance from the interface 130. One or more of the hydroxyl group concentration, the titania concentration, the CTE slope, the expansivity slope, and/or the birefringence may be measured at a second point 180, where the second point 180 is a portion of the second glass substrate 120 positioned at the second distance the interface 130. One or more of the hydroxyl group concentration, the titania concentration, the CTE slope, the expansivity slope, and/or the birefringence may be measured at an interface point 190, where the interface point 190 is a portion of the interface 130 positioned at the first distance from the first point 170 and/or positioned at the second distance from the second point 180.

These measured parameters at the first glass substrate 110, the interface 130, and/or the second glass substrate 120, or along the line trace 162, the line trace 164, and/or the line trace 166 may be compared to determine an overall uniformity in the glass article 100.

In embodiments, a peak-to-valley difference of a hydroxyl group concentration measured along the line trace 162 may be less than or equal to 30 ppm, less than or equal to 25 ppm, less than or equal to 20 ppm, less than or equal to 15 ppm, less than or equal to 10 ppm, or less than or equal to 5 ppm. In embodiments, a peak-to-valley difference of a hydroxyl group concentration measured along the line trace 164 may be less than or equal to 30 ppm, less than or equal to 25 ppm, less than or equal to 20 ppm, less than or equal to 15 ppm, less than or equal to 10 ppm, or less than or equal to 5 ppm. In embodiments, a peak-to-valley difference of a hydroxyl group concentration measured along the line trace 166 may be less than or equal to 30 ppm, less than or equal to 25 ppm, less than or equal to 20 ppm, less than or equal to 15 ppm, less than or equal to 10 ppm, or less than or equal to 5 ppm. As used herein, “the peak-to-valley difference of a hydroxyl group concentration” refers to the absolute value of a difference between a maximum hydroxyl group concentration and a minimum hydroxyl group concentration. In embodiments, the peak-to-valley difference of a hydroxyl group concentration measured along the line trace 162, the line trace 164, and/or the line trace 166 is measured at a spacing of less than or equal to 0.1 mm, less than or equal to 10 μm, less than or equal to 5 μm, or less than or equal to 1 μm.

In embodiments, an absolute value of a difference of an hydroxyl group concentration at the interface 130 and a hydroxyl group concentration at a depth of the first glass substrate 110 of the first distance from the interface 130 may be less than or equal to 30 ppm, less than or equal to 25 ppm, less than or equal to 20 ppm, less than or equal to 15 ppm, less than or equal to 10 ppm, or less than or equal to 5 ppm. In embodiments, an absolute value of a difference of the hydroxyl group concentration at the interface 130 and the hydroxyl group concentration at a depth of the second glass substrate 120 of the second distance from the interface 130 may be less than or equal to 30 ppm, less than or equal to 20 ppm, less than or equal to 10 ppm, or less than or equal to 5 ppm.

The hydroxyl group concentration may be determined by Fourier Transform Infrared (FTIR) spectroscopy in transmission, as described herein. As used herein, “in transmission” means that the light is directed through a portion of the sample to determine the hydroxyl group concentration (rather than using light that is reflected from the substrate to be measured to determine the hydroxyl group concentration). Therefore, “in transmission” requires a non-scattering surface.

In embodiments, an FTIR line scan of the glass article 100 may be performed along the line trace 162, the line trace 164, and/or the line trace 166. The samples for measurement may be prepared by sectioning the glass article 100 into a scanning portion comprising a portion of the glass article 100 that extends between or beyond the trace 150 and the interface 130, between or beyond the trace 160 and the interface 130, and/or between or beyond the trace 150 and the trace 160. The scanning portion may have a thickness corresponding to the desired measurement technique used, such as a thickness of about 1 mm, about 2 mm, about 3 mm, about 4 mm, or about 5 mm. The scanning portion may have a thickness extending parallel to the interface 130.

In embodiments, an FTIR scan of the glass article 100 may be performed by sectioning the glass article 100 into a first portion comprising a 1 mm thick portion of the first glass substrate 110 positioned at the first distance from the interface 130 prior to the sectioning, a second portion comprising a 1 mm thick portion of the second glass substrate 120 positioned at the second distance from the interface 130 prior to the sectioning, and an interface portion comprising a 1 mm thick portion of the interface 130. The interface portion may have one surface congruent with the interface and a thickness extending into either the first portion or the second portion prior to the sectioning.

A surface of the sample (the scanning portion, the first portion, the second portion, and/or the interface portion) are prepared by polishing the surfaces prior to measurement. The sample may be loaded into the FTIR instrument for measurement and a beam alignment and background measurement may be performed first. Then the FTIR instrument may be used to measure the fundamental absorption band for hydroxyl groups centered near 3670 cm⁻¹ at one or more positions within the sample. In the measurement, the absorption intensity of the hydroxyl absorption band relative to the background signal (baseline) is determined, where the background signal is defined as a straight line between the points of lowest intensity immediately surrounding the hydroxyl absorption peak. The peak hydroxyl absorption intensity is then divided by the thickness (e.g. H=1.0 mm) of the portion to yield a hydroxyl absorption coefficient β_{OH}. The hydroxyl group concentration can then be derived from the hydroxyl absorption coefficient β_{OH} using Equation 2 (EQU. 2).

$$C = ( \frac{{β}_{OH}}{ε} ) ( \frac{{MW}_{OH}}{{D}_{glass}} ) \times {10}^{6} \qquad EQU . 2$$

In EQU. 2, C is the hydroxyl group concentration in parts per million (ppm) for a particular point of the sample, β_{OH} is the hydroxyl absorption coefficient of the glass, ε is the molar absorptivity of the peak hydroxyl absorption intensity for the hydroxyl absorption band centered near 3670 cm⁻¹ (e.g. 77.5 L·mol⁻¹·cm⁻¹), MW_{OH} is the molecular weight of hydroxyl (17 g/mol), and D_{glass} is the density of glass (g/cm³). It is noted that C refers to the hydroxyl concentration of the point of the sample. The above-disclosed FTIR analysis is further disclosed in K. M. Davis, et al, “Quantitative infrared spectroscopic measurement of hydroxyl group concentration in silica glass,” J. Non-Crystalline Solids, 203 (1996) 27-36, which is incorporated by reference herein.

In embodiments, the hydroxyl group concentration may be measured at a plurality of points along the line trace 162, the line trace 164, and/or the line trace 166 to determine a peak-to-valley difference of the hydroxyl group concentration.

In other embodiments, the hydroxyl group concentration may be measured at a plurality of segments within the first portion, the second portion, and/or the interface portion. The average hydroxyl group concentration among the plurality of segments may be calculated and is referred to herein as the average hydroxyl group concentration of the portion. In embodiments where the hydroxyl group concentration is measured at only one point in the first portion, the second portion, or the interface portion, it should be understood that “average hydroxyl group concentration” and “hydroxyl group concentration” refer to the single measurement of said portion. Gradients or uniformity in hydroxyl group concentration of the glass article 100 can be determined by comparing the average hydroxyl group concentration determined for the first portion, the interface portion, and/or the second portion.

In embodiments, the hydroxyl group concentration at the interface 130 may be greater than 0 ppm and less than or equal to 1,500 ppm. In embodiments, the hydroxyl group concentration at the interface 130 may be greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm. In embodiments, the hydroxyl group concentration at the interface 130 may be greater than or equal to 1,000 ppm and less than or equal to 1,400 ppm.

In embodiments, the hydroxyl group concentration at a depth of the first glass substrate 110 of the first distance from the interface 130 may be greater than 0 ppm and less than or equal to 1,500 ppm. In embodiments, the hydroxyl group concentration at a depth of the first glass substrate 110 of the first distance from the interface 130 may be greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm. In embodiments, the hydroxyl group concentration at a depth of the first glass substrate 110 of the first distance from the interface 130 may be greater than or equal to 1,000 ppm and less than or equal to 1,400 ppm.

In embodiments, the hydroxyl group concentration at a depth of the second glass substrate 120 of the second distance from the interface 130 may be greater than 0 ppm and less than or equal to 1,500 ppm. In embodiments, the hydroxyl group concentration at a depth of the second glass substrate 120 of the second distance from the interface 130 may be greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm. In embodiments, the hydroxyl group concentration at a depth of the second glass substrate 120 of the second distance from the interface 130 may be greater than or equal to 1,000 ppm and less than or equal to 1,400 ppm.

The uniformity of the titania concentration in the glass article 100 may also be determined. The titania concentration may be determined along the line trace 162, the line trace 164, and/or the line trace 166, or may be determined at a plurality of segments within each of the first portion, the interface portion, and/or the second portion. The peak-to-valley difference of the titania concentration along the line trace 162, the line trace 164, and/or the line trace 166 may be calculated. As used herein, “the peak-to-valley difference of the titania concentration” refers to the absolute value of a difference between a maximum titania concentration and a minimum titania concentration. The average titania concentration among the plurality of segments for each portion may be calculated and is referred to herein as the average titania concentration of the portion. In embodiments where the titania concentration is measured at only one point in the first portion, the second portion, or the interface portion, it should be understood that “average titania concentration” refers to the single measurement of said portion. Gradients or uniformity in titania concentration of the glass article 100 can be determined by comparing the average titania concentration determined for the first portion, the interface portion, and/or the second portion, or may be determined by calculating the peak-to-valley difference of the titania concentration.

To determine the peak-to-valley difference of the titania concentration along the line trace 162, the line trace 164, and/or the line trace 166, the refractive index variation at one or more points along the line trace may be measured.

To determine the average titania concentration of each portion, the refractive index at one or more regions within the first portion, the interface portion, and/or the second portion may be measured. For instance, the refractive index of each sample may be measured using a Zygo Verifire HD from Zygo Corporation with a 270 micron pixel size resolution operating at a wavelength of 633 nm. The optical interferometer may be set so that the pixels are square with a size of 270 microns×270 microns, and each pixel extends through the full thickness (h) of each sample (about 1.0 mm). The refractive index may be measured at each pixel within the sample. An absolute value of the difference between the maximum refractive index measurement and the minimum refractive index measurement may be determined and is referred to as the peak-to-valley titania concentration. The measurement at each pixel may be averaged together to determine the average refractive index of each sample.

The titania concentration may be determined based upon the refractive index variation of each pixel using the relationship in Equation 3 (EQU. 3).

$$55 ppm Δ RI = 0.0125 \% Δ {C}_{Ti} \qquad EQU . 3$$

In EQU. 3, ΔRI is the refractive index variation measured at a wavelength of 633 nm, and Cri is the variation of concentration of titania (in wt. %) of the sample. It is noted that the above relationship in EQU. 3 assumes that the only influence on the change of refractive index is from titania.

In embodiments, a peak-to-valley difference of the titania concentration along the line trace 162, may be greater than or equal to 30 ppm. In embodiments, a peak-to-valley difference of the titania concentration along the line trace 162 may be less than or equal to 700 ppm, less than or equal to 400 ppm, or less than or equal to 200 ppm. In embodiments, a peak-to-valley difference of the titania concentration along the line trace 164, may be greater than or equal to 30 ppm. In embodiments, a peak-to-valley difference of the titania concentration along the line trace 164 may be less than or equal to 700 ppm, less than or equal to 400 ppm, or less than or equal to 200 ppm. In embodiments, a peak-to-valley difference of the titania concentration along the line trace 166, may be greater than or equal to 30 ppm. In embodiments, a peak-to-valley difference of the titania concentration along the line trace 166 may be less than or equal to 700 ppm, less than or equal to 400 ppm, or less than or equal to 200 ppm. Without intending to be bound by any particular theory, it is believed that a reduced peak-to-valley difference of the titania concentration along the line trace 162, the line trace 164, and/or the line trace 166 may reduce stress across the glass article 100, which may reduce birefringence at the interface 130.

In embodiments, an absolute value of a difference of an average titania concentration at the interface 130 and an average titania concentration at a depth of the first glass substrate 110 of the first distance from the interface 130 may be greater than or equal to 30 ppm. In embodiments, an absolute value of a difference of an average titania concentration at the interface 130 and an average titania concentration at a depth of the second glass substrate 120 of the second distance from the interface 130 may be greater than or equal to 30 ppm. In embodiments, an absolute value of a difference of an average titania concentration at the interface 130 and an average titania concentration at a depth of the first glass substrate 110 of the first distance from the interface 130 may be less than or equal to 700 ppm, less than or equal to 400 ppm, or less than or equal to 200 ppm. In embodiments, an absolute value of a difference of an average titania concentration at the interface 130 and an average titania concentration at a depth of the second glass substrate 120 of the second distance from the interface 130 may be less than or equal to 700 ppm, less than or equal to 400 ppm, or less than or equal to 200 ppm. An absolute value of a difference of an average titania concentration at a depth of the first glass substrate 110 of the first distance from the interface 130 and an average titania concentration at a depth of the second glass substrate 120 of the second distance from the interface 130 may be less than or equal to 0.15 weight percent (wt. %). Without intending to be bound by any particular theory, it is believed that more uniform titania concentration between the first glass substrate 110 and the second glass substrate 120 may reduce stress across the glass article 100, which may reduce birefringence at the interface 130.

The Coefficient of Thermal Expansion (CTE) variation of each sample may also be determined from the refractive index variation of each portion using the relationship in Equation 4 (EQU. 4).

$$55 ppm Δ RI = 1 ppb / K Δ CTE \qquad EQU . 4$$

In EQU. 4, ΔRI is the refractive index variation of each portion, and ΔCTE is the coefficient of thermal expansion variation (in K⁻¹) of each sample. It is noted that the above relationship assumes that the only influence on the change of refractive index is from ΔCTE. Methods known in the art may be used to determine the absolute CTE and CTE slope of the sample. The CTE slope of each portion may also be determined based on the average slope of CTE of each portion as a function of temperature (in ppb/K²).

In embodiments, a peak-to-valley difference of the CTE slope along the line trace 162 may be less than or equal to 0.1 ppb/K², wherein the CTE slope is measured at 20° C. In embodiments, the peak-to-valley difference of the CTE slope along the line trace 164 may be less than or equal to 0.1 ppb/K², wherein the CTE slope is measured at 20° C. In embodiments, the peak-to-valley difference of the CTE slope along the line trace 166 may be less than or equal to 0.1 ppb/K², wherein the CTE slope is measured at 20° C. As used herein, “the peak-to-valley difference of the CTE slope” refers to the absolute value of a difference between a maximum CTE slope and a minimum CTE slope.

In embodiments, the absolute value of a difference of a CTE slope at the interface 130 and a CTE slope at a depth of the first glass substrate 110 of the first distance from the interface 130 may be less than or equal to 0.1 ppb/K², wherein the CTE slope is measured at 20° C. In embodiments, the absolute value of a difference of a CTE slope at the interface 130 and a CTE slope at a depth of the second glass substrate 120 of the second distance from the interface 130 may be less than or equal to 0.1 ppb/K², wherein the CTE slope is measured at 20° C. In embodiments, an absolute value of a difference of a CTE slope at a depth of the first glass substrate 110 of the first distance from the interface 130 and a CTE slope at a depth of the second glass substrate 120 of the second distance from the interface 130 may be less than or equal to 0.1 ppb/K².

The uniformity of an expansivity slope of the glass article 100 may also be determined. In embodiments, the expansivity slope may be measured along the line trace 162, the line trace 164, and/or the line trace 166. In embodiments, the expansivity slope may be measured at each of the first portion, the interface portion, and/or the second portion. Gradients or uniformity in expansivity slope of the glass article 100 can be determined by comparing the expansivity slope determined for the first portion, the interface portion, and/or the second portion. Methods known in the art may be used to determine the expansivity slope of the sample

In embodiments, a peak-to-valley expansivity slope along the line trace 162 may be less than or equal to 2.0 ppb/K², less than or equal to 1.0 ppb/K², or less than or equal to 0.5 ppb/K². In embodiments, a peak-to-valley expansivity slope along the line trace 164 may be less than or equal to 2.0 ppb/K², less than or equal to 1.0 ppb/K², or less than or equal to 0.5 ppb/K². In embodiments, a peak-to-valley expansivity slope along the line trace 166 may be less than or equal to 2.0 ppb/K², less than or equal to 1.0 ppb/K², or less than or equal to 0.5 ppb/K².

In embodiments, an absolute value of a difference of an expansivity slope at the interface 130 and an expansivity slope at a depth of the first glass substrate 110 of the first distance from the interface 130 may be greater than or equal to 0.01 ppb/K², greater than or equal to 0.05 ppb/K², or greater than or equal to 0.1 ppb/K². In embodiments, an absolute value of a difference of an expansivity slope at the interface 130 and an expansivity slope at a depth of the second glass substrate 120 of the second distance from the interface 130 may be less than or equal to 2.0 ppb/K², less than or equal to 1.0 ppb/K², or less than or equal to 0.5 ppb/K². In embodiments, an absolute value of a difference of an expansivity slope at the interface 130 and an expansivity slope at a depth of the second glass substrate 120 of the second distance from the interface 130 may be greater than or equal to 0.01 ppb/K². In embodiments, an absolute value of a difference of an expansivity slope at a depth of the first glass substrate 110 of the first distance from the interface 130 and an expansivity slope at a depth of the second glass substrate 120 of the second distance from the interface 130 may be less than or equal to 2.0 ppb/K², less than or equal to 1.0 ppb/K², or less than or equal to 0.5 ppb/K².

In embodiments, an absolute value of a difference of an expansivity slope at the interface 130 and an expansivity slope at a depth of the first glass substrate 110 of the first distance from the interface 130 may be less than or equal to 2.0 ppb/K², less than or equal to 1.0 ppb/K², or less than or equal to 0.5 ppb/K². In embodiments, an absolute value of a difference of an expansivity slope at the interface 130 and an expansivity slope at a depth of the first glass substrate 110 of the first distance from the interface 130 may be greater than or equal to 0.01 ppb/K². In embodiments, an absolute value of a difference of an expansivity slope at the interface 130 and an expansivity slope at a depth of the second glass substrate 120 of the second distance from the interface 130 may be less than or equal to 2.0 ppb/K², less than or equal to 1.0 ppb/K², or less than or equal to 0.5 ppb/K². In embodiments, an absolute value of a difference of an expansivity slope at the interface 130 and an expansivity slope at a depth of the second glass substrate 120 of the second distance from the interface 130 may be greater than or equal to 0.01 ppb/K². In embodiments, an absolute value of a difference of an expansivity slope at a depth of the first glass substrate 110 of the first distance from the interface 130 and an expansivity slope at a depth of the second glass substrate 120 of the second distance from the interface 130 may be less than or equal to 2.0 ppb/K², less than or equal to 1.0 ppb/K², or less than or equal to 0.5 ppb/K².

The birefringence of the glass article 100 may also be determined according to methods known in the art. A reduced birefringence in the glass article may indicate decreased strain in the glass article.

In embodiments, a birefringence of the glass article, as measured at the interface 130 may be less than or equal to 50 nm/cm, less than or equal to 20 nm/cm, or less than or equal to 10 nm/cm.

In embodiments, a region of the glass article defined between a depth of the first glass substrate of the first distance from the interface and a depth of the second glass substrate of a second distance from the interface may have a birefringence of less than or equal to 50 nm/cm, less than or equal to 20 nm/cm, or less than or equal to 10 nm/cm². In embodiments, the birefringence may be measured within the region at a spacing of less than or equal to 0.1 mm, less than or equal to 10 μm, less than or equal to 5 μm, or less than or equal to 1 μm.

In embodiments, the birefringence along the line trace 162 may be may be less than or equal to 50 nm/cm, less than or equal to 20 nm/cm, or less than or equal to 10 nm/cm. In embodiments, the birefringence along the line trace 164 may be may be may be less than or equal to 50 nm/cm, less than or equal to 20 nm/cm, or less than or equal to 10 nm/cm. In embodiments, the birefringence along the line trace 166 may be less than or equal to 50 nm/cm, less than or equal to 20 nm/cm, or less than or equal to 10 nm/cm. In embodiments, the birefringence may be measured a spacing of less than or equal to 0.1 mm, less than or equal to 10 μm, less than or equal to 5 μm, or less than or equal to 1 μm.

In embodiments, a birefringence of the glass article, as measured at a depth of the first glass substrate 110 of the first distance from the interface 130 may be less than or equal to 50 nm/cm, less than or equal to 20 nm/cm, or less than or equal to 10 nm/cm.

In embodiments, a birefringence of the glass article, as measured at a depth of the second glass substrate 120 of the second distance from the interface 130 may be less than or equal to 50 nm/cm, less than or equal to 20 nm/cm, or less than or equal to 10 nm/cm.

The first portion of the first glass substrate 110, the second portion of the second glass substrate 120, and the interface portion of the interface 130 may be further characterized by physical dimensions. In embodiments, the first portion of the first glass substrate 110 may have a first height, a first length, a first width, and a first cross-section, wherein the first cross-section is perpendicular to a direction of the first height of the first portion of the first glass substrate. The second portion of the second glass substrate 120 may have a second height, a second length, a second width, and a second cross-section, wherein the second cross-section is perpendicular to a direction of the second height of the second portion of the second glass substrate 120. The third portion of the interface 130 may have a third height, a third length, a third width, and a third cross-section, wherein the third cross-section is perpendicular to a direction of the third height of the third portion of the interface. In embodiments, the first cross-section may be parallel to the third cross-section, and the second cross-section may be parallel to the third cross-section. A surface of the first cross-section proximal to the third cross-section may be positioned at the first distance from a surface of the third cross-section proximal to the first cross-section. A surface of the second cross-section proximal to the third cross-section may be positioned at the second distance from a surface of the third cross-section proximal to the second cross-section. The first length, the first width, the second length, the second width, the third length, and the third width may be independently greater than or equal to 1 mm, greater than or equal to 5 mm, greater than or equal to 10 mm, greater than or equal to 25 mm, or greater than or equal to 50 mm. The first length, the first width, the second length, the second width, the third length, and the third width may be independently less than or equal to 100 mm, less than or equal to 50 mm, less than or equal to 25 mm, less than or equal to 10 mm, less than or equal to 5 mm, or less than or equal to 2 mm. The first height, the second height, and the third height may be about 1 mm.

In embodiments, the average hydroxyl group concentration, the average titania concentration, the CTE slope, and/or the expansivity slope of the first portion of the first glass substrate 110 may be measured at the first cross-section. The average hydroxyl group concentration, the average titania concentration, the CTE slope, and/or the expansivity slope of the second portion of the second glass substrate 120 may be measured at the second cross-section. The average hydroxyl group concentration, the average titania concentration, the CTE slope, and/or the expansivity slope of the interface portion of the interface 130 may be measured at the third cross-section.

In embodiments, the first portion of the first glass substrate 110 may have an average first hydroxyl group concentration, as measured at the first cross-section; the second portion of the second glass substrate 120 may have an average second hydroxyl group concentration, as measured at the second cross-section; and the third portion of the interface 130 may have an average interface hydroxyl group concentration, as measured at the third cross-section. In embodiments, an absolute value of a difference of a hydroxyl group concentration between the average first hydroxyl group concentration and the average interface hydroxyl group concentration may be less than or equal to 30 parts per million (ppm), an absolute value of a difference of a hydroxyl group concentration between the average second hydroxyl group concentration and the average interface hydroxyl group concentration may be less than or equal to 30 ppm, or both.

In embodiments, the glass article 100 comprising the first glass substrate 110 and the second glass substrate 120 may have a mass of greater than 1 kilogram, greater than 10 kilograms, or greater than 25 kilograms.

In embodiments, the first glass substrate 110 of the glass article 100 may have an average thickness of greater than or equal to 10 mm, greater than or equal to 25 mm, or greater than or equal to 50 mm, as measured perpendicular to the interface 130. In embodiments, the first glass substrate 110 of the glass article 100 may have an average thickness of less than or equal to about 50 cm, such as less than or equal to about 40 cm, less than or equal to about 30 cm, less than or equal to about 20 cm, less than or equal to about 10 cm, as measured perpendicular to the interface 130. In embodiments, the second glass substrate 120 of the glass article 100 may have an average thickness of greater than or equal to 10 mm, greater than or equal to 25 mm, or greater than or equal to 50 mm, as measured perpendicular to the interface 130. In embodiments, the second glass substrate 120 of the glass article 100 may have an average thickness of less than or equal to about 50 cm, such as less than or equal to about 40 cm, less than or equal to about 30 cm, less than or equal to about 20 cm, less than or equal to about 10 cm, as measured perpendicular to the interface 130.

### EXAMPLES

Embodiments will be further clarified by the following examples. It should be understood that these examples are not limiting to the embodiments described above.

### Example 1A—Method of Forming a Sealed Glass Article

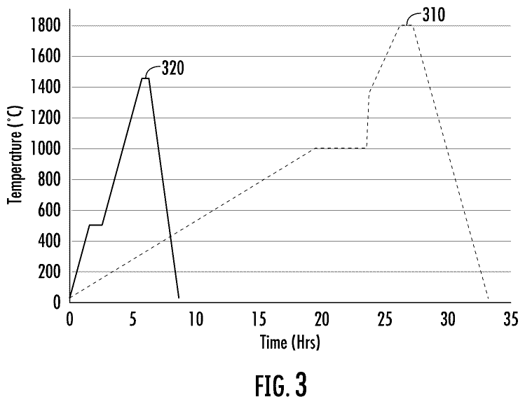

In Example 1A, a sealed glass article comprising a first glass substrate and a second glass substrate was produced. The first glass substrate had a hydroxyl group concentration of about 825 ppm, and the second glass substrate had a hydroxyl group concentration of about 950 ppm. The first glass substrate and the second glass substrate had length (L), width (W), and height (H) dimensions of approximately 3.5 inches (in) (L)×3.5 in (W)×1.4 in (H). A first interface surface of the first glass substrate perpendicular to the H and a second interface surface of the second glass substrate perpendicular to the H were positioned 1 mm apart with spacers at the corners of the first interface surface and the second interface surface to form a glass article precursor. The glass article precursor was positioned in a non-hermetically sealed furnace. Steam and helium were introduced to the furnace such that a sealing environment of the furnace was maintained at a total pressure of 101.325 kPa (1 atmosphere). The sealing environment comprised 25 volume percent (vol %) steam and 75 vol % helium, based on the total volume of gases in the sealing environment. The glass article precursor was heated according to the heating profile of trace 310 of FIG. 3 to form a glass article.

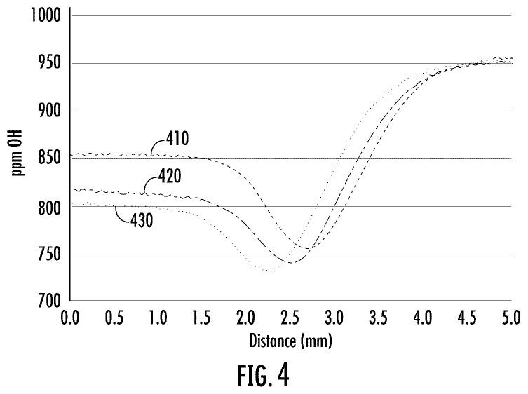

The hydroxyl group concentration of the glass article of Example 1A was measured, as described herein, to determine a hydroxyl group uniformity across the interface, as shown in FIG. 4. The hydroxyl group concentration of the glass article was measured across three separate 5 mm traces perpendicular to the interface, where the interface was at approximately 2.5 mm. Trace 410 was measured at a front-most region of the glass article relative to the position of the glass article precursor in the furnace, trace 420 was measured at a middle-most region of the glass article, and trace 430 was measured at a back-most region of the glass article relative to the position of the glass article precursor in the furnace. The portions of each plot at a distance less than about 2.5 mm indicate the hydroxyl group concentrations in the first glass substrate, and the portions of each plot at a distance greater than about 2.5 mm indicate the hydroxyl group concentrations in the second glass substrate. As shown in FIG. 4, the glass article at the interface (i.e., at about 2.5 mm) had a hydroxyl group concentration of about 90 ppm less than a hydroxyl group concentration of the bulk glass of the first glass substrate. Further, the glass article at the interface had a hydroxyl group concentration of about 200 ppm less than a hydroxyl group concentration of the bulk glass of the second glass substrate.

The titania concentration of the glass article of Example IA was measured, as described herein, to determine a titania concentration uniformity across the interface, as shown in FIG. 5. Trace 510 depicts the titania concentration at the first glass substrate (distance less than about 8 mm), at the second glass substrate (distance greater than about 8 mm), and the interface (distance equal to about 8 mm). As shown in FIG. 5, the glass article had a difference in titania concentration between the first glass substrate and the second glass substrate of about 0.20 wt. %.

### Example 1B—Method of Forming a Sealed Glass Article Having a Reduced Hydroxyl Group Concentration at the Interface

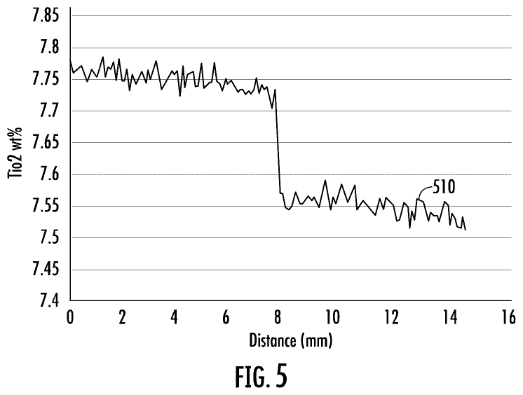

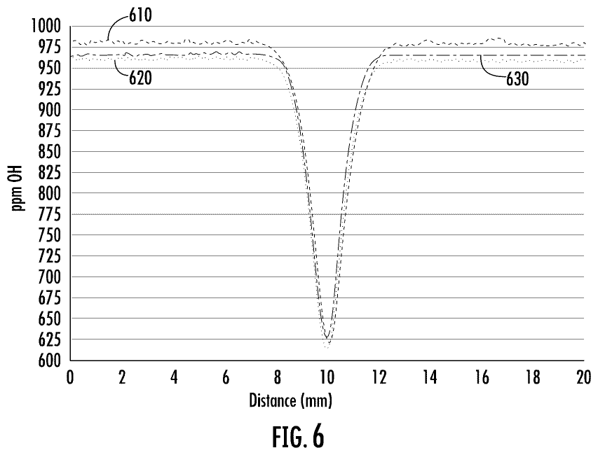

In Example 1B, a sealed glass article comprising a first glass substrate and a second glass substrate was produced. An initial glass substrate was cut into two glass substrates, a first glass substrate, and a second glass substrate, both of which had had a hydroxyl group concentration of about 970 ppm. The first glass substrate and the second glass substrate were positioned to form a glass article precursor, as described in Example 1A. The glass article precursor was positioned in a non-hermetically sealed furnace having a sealing environment and heating profile as described in Example 1A. The hydroxyl group concentration of the glass article (y-axis) as a function of distance (x-axis) is depicted in FIG. 6, where the interface is at about a distance of 10 mm, the first glass substrate is at a distance of about less than 10 mm, and the second glass substrate is at a distance of about greater than 10 mm. Trace 610 was measured at a front-most region of the glass article relative to the position of the glass article in the furnace, trace 620 was measured at a middle-most region of the glass article, and trace 630 was measured at a back-most region of the glass article relative to the position of the glass article in the furnace. As shown in FIG. 6, the hydroxyl group concentration at the interface was about 350 ppm less than the hydroxyl group concentration at a depth of the first glass substrate of 5 mm from the interface, and about 350 ppm less than the hydroxyl group concentration at a depth of the second glass substrate of 5 mm from the interface.

### Example 1C—Method of Forming a Sealed Glass Article Having an Increased Hydroxyl Group Concentration at the Interface

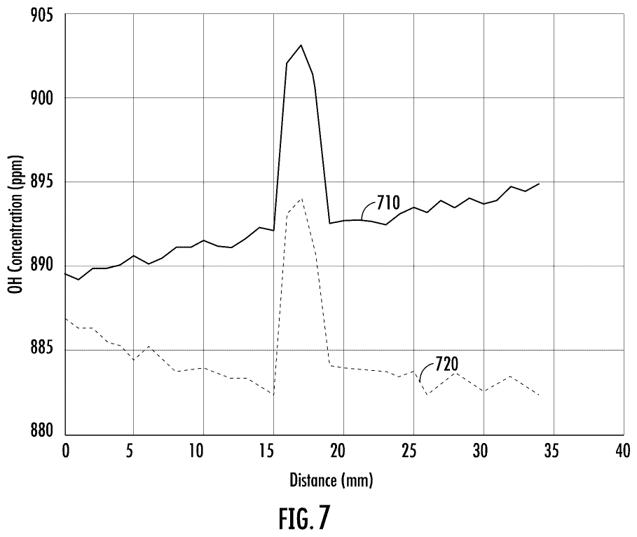

In Example 1C, a sealed glass article comprising a first glass substrate stacked sealed to a second glass substrate according to the methods disclosed herein was produced. The first glass substrate and the second glass substrate had a hydroxyl group concentration of about 890 ppm. The first glass substrate and the second glass substrate had length (L), width (W), and height (H) dimensions of approximately 25 mm (L)×25 mm (W)×18 mm (H). The first glass substrate and the second glass substrate were spaced apart by a distance of about 1 mm to form a glass article precursor. The glass article precursor was heated at 1300° C. for 5 minutes in a dry furnace The hydroxyl group concentration of a portion of the glass article (y-axis) as a function of distance (x-axis) perpendicular to the interface is depicted in FIG. 7, where the interface is at about a distance of 17 mm, the first glass substrate is at a distance of about less than 17 mm, and the second glass substrate is at a distance of about greater than 17 mm. Line trace 710 depicts the hydroxyl group concentration, as measured from a first slice. Line trace 720 depicts the hydroxyl group concentration, as measured from A second slice. As shown in FIG. 7, by having an increased concentration of steam in the sealing environment during heating, the hydroxyl group concentration at the interface was increased. That is, the sealing environment can be modified to compensate for hydroxyl group loss during the heating, thereby causing adsorption of hydroxyl groups at the first interface surface and the second interface surface.

### Example 2—Modeled Method of Forming a Sealed Glass Article from Glass Substrates of Varying Equilibrium Hydroxyl Group Concentration and Corresponding Partial Pressure of Water During Heating

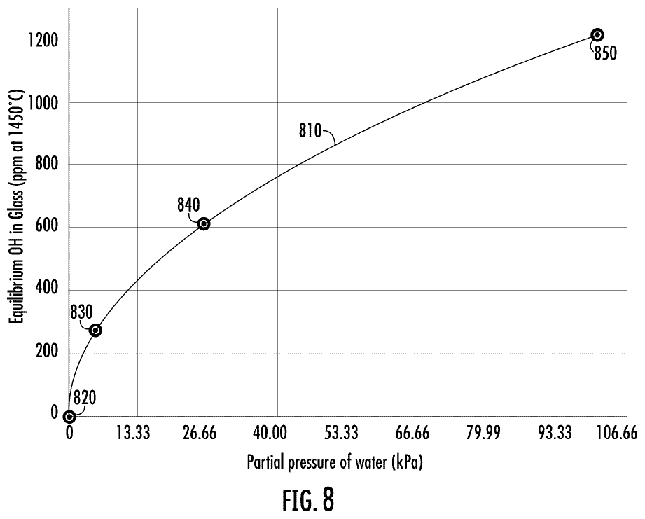

In Example 2, an equilibrium hydroxyl group concentration in a bulk glass substrate was modelled as a function of partial pressure of water at a fixed temperature, as described herein at EQU. 1, where A=492 and B=1555. A sealing temperature of 1450° C. was used, and the resulting plot 810 is depicted in FIG. 8, where the equilibrium hydroxyl group concentration of the bulk glass substrate (y-axis) is plotted as a function of the partial pressure of water in kPa (x-axis). Additionally, points 820, 830, 840, and 850 correspond to the approximate equilibrium hydroxyl group concentration of the bulk glass substrate for a sealing environment at 101.325 kPa (1 atm) comprising 0 vol %, 5 vol %, 25 vol % and 100 vol % steam, respectively (the balance of the gas in the sealing environment being helium). For instance, based on FIG. 8, glass substrates having an equilibrium hydroxyl group concentration of about 600 ppm may be fused at a scaling temperature of 1450° C. and a sealing environment at a total pressure of 101.325 kPa and 25 vol % steam to achieve a sealed glass article having improved hydroxyl group uniformity at the interface and in the bulk glass substrate.

### Example 3—Modeled Method of Forming a Sealed Glass Article from Glass Substrates of Varying Equilibrium Hydroxyl Group Concentration, Partial Pressure of Water During Heating and Heating Temperature

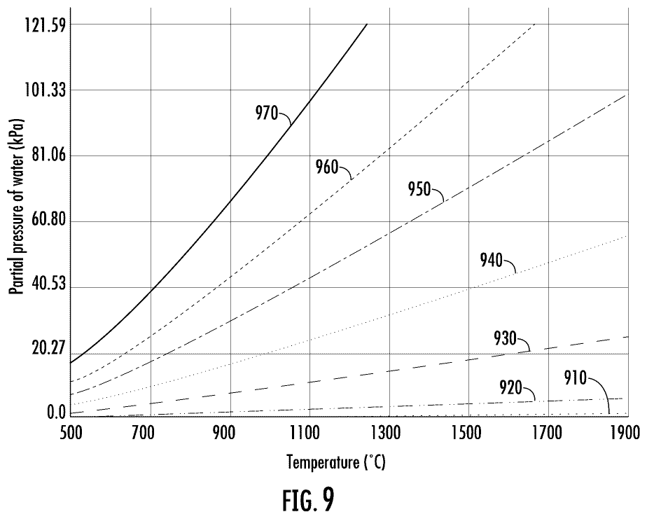

In Example 3, partial pressure of water as a function of temperature for glass substrates having various equilibrium hydroxyl group concentrations was modeled, according to EQU. 1 with A=492 and B=1555, as described in the present disclosure. EQU. 1 was plotted for C_{OH}[ppm] of 100 ppm, 250 ppm, 500 ppm, 750 ppm, 1,000 ppm, 1,200 ppm, and 1,500 ppm in FIG. 9 corresponding to trace 910, 920, 930, 940, 950, 960, and 970, respectively. As shown in FIG. 9, the partial pressure of steam may be increased during an increase in the scaling temperature to maintain a hydroxyl group homogeneity between the interface and the glass substrate.

### Example 4—Method of Forming a Sealed Glass Article from Glass Substrates of Varying Equilibrium Hydroxyl Group Concentration and at Varying Sealing Environments

In Example 4, sealed glass articles comprising a first glass substrate and a second glass substrate were produced. The first glass substrate and the second glass substrate had length (L), width (W), and height (H) dimensions of approximately 3.5 inches (L)×3.5 inches (W)×8 mm (H). A first interface surface of the first glass substrate perpendicular to the H and a second interface surface of the second glass substrate perpendicular to the H were positioned 1 mm apart with spacers at the corners of the first interface surface and the second interface surface to form a glass article precursor. The glass article precursor was positioned in a non-hermetically sealed MoSi₂ furnace. Steam and helium were introduced to the furnace such that a sealing environment of the furnace was maintained at a total pressure of 101.325 kPa (1 atmosphere). The helium and liquid water were pumped to a first heater operable to heat the mixture at 320° C. and then transfer the gas mix to the furnace. The sealing environment was configured to have a flow rate constant of 1 standard liter per minute with 1 exchange every 1 to 3 minutes, where an exchange is defined as the replacement of a volume of air in the sealing environment equivalent to a volume of the sealing environment. The glass article precursors of Example 4 were heated according to the heating profile of trace 320 of FIG. 3 to form the glass articles.

### Example 4A—5 Vol % Steam/95 Vol % Helium

In Example 4A, glass article precursors were treated in a sealing environment comprising 5 vol % steam and 95 vol % helium. The glass article precursors of Example 4A included matching first and second glass substrates having a hydroxyl group concentration of 500 ppm, 225 ppm, and 100 ppm, corresponding to Ex. 4A-1, Ex. 4A-2, and Ex. 4A-3, respectively. After the heating, the glass article precursors were converted into glass articles. The hydroxyl group concentration of the glass articles along an axis perpendicular to the interface were measured and are depicted in FIG. 10, where trace 1010, 1020, and 1030 correspond to Ex. 4A-1, Ex. 4A-2, and Ex. 4A-3, respectively. The approximate position of the interface is indicated by line 1040. As shown by 1010, the heating resulted in desorption of the hydroxyl groups at the interface and an absolute value of a difference between the hydroxyl group concentration at the interface and the hydroxyl group concentration at the bulk glass substrate of greater than 30 ppm. As shown by 1030, the heating resulted in adsorption of the hydroxyl groups at the interface and an absolute value of a difference between the hydroxyl group concentration at the interface and the hydroxyl group concentration at the bulk glass substrate of greater than 30 ppm. As shown by at 1020, the heating resulted in minimal change of the hydroxyl groups at the interface and an absolute value of a difference between the hydroxyl group concentration at the interface and the hydroxyl group concentration at the bulk glass substrate of less than about 5 ppm.

### Example 4B—25 Vol % Steam/75 Vol % Helium

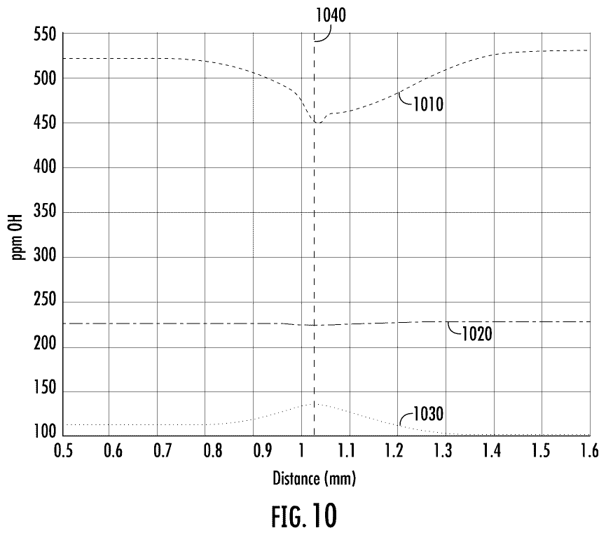

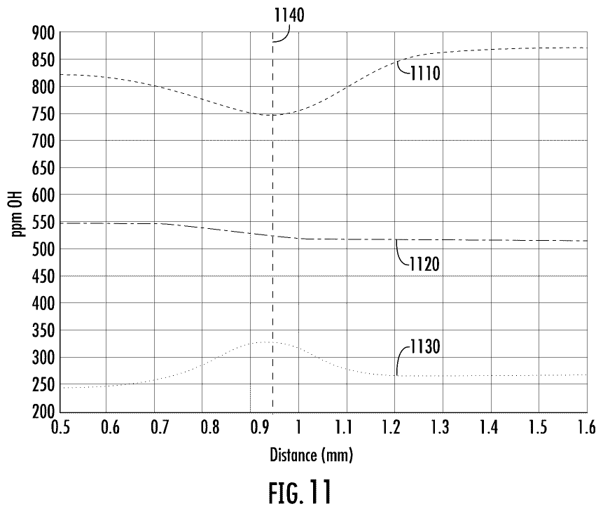

In Example 4B, glass article precursors were treated in a sealing environment comprising 25 vol % steam and 75 vol % helium. The glass article precursors of Example 4B included matching first and second glass substrates having a hydroxyl group concentration of 850 ppm, 525 ppm, and 250 ppm, corresponding to Ex. 4B-1, Ex. 4B-2, and Ex. 4B-3, respectively. After the heating, the glass article precursors were converted into glass articles. The hydroxyl group concentration of the glass articles along an axis perpendicular to the interface were measured and are depicted in FIG. 11, where trace 1110, 1120, and 1130 correspond to Ex. 4B-1, Ex. 4B-2, and Ex. 4B-3, respectively. The approximate position of the interface is indicated by line 1140. As shown by 1110, the heating resulted in desorption of the hydroxyl groups at the interface and an absolute value of a difference between the hydroxyl group concentration at the interface and the hydroxyl group concentration at the bulk glass substrate of greater than 30 ppm. As shown by 1130, the heating resulted in adsorption of the hydroxyl groups at the interface and an absolute value of a difference between the hydroxyl group concentration at the interface and the hydroxyl group concentration at the bulk glass substrate of greater than 30 ppm. As shown by 1120, the heating resulted in minimal change of the hydroxyl groups at the interface and an absolute value of a difference between the hydroxyl group concentration at the interface and the hydroxyl group concentration at the bulk glass substrate of less than about 5 ppm.

The results of Example 4 show that, for glass substrates having a given bulk hydroxyl group concentration, the proportion of steam in the sealing environment can be modified to adjust the shape of the hydroxyl group concentration profile in the vicinity of the interface. For instance, as shown by trace 1020 in FIG. 10 and trace 1120 in FIG. 11, for two glass substrates having a given bulk hydroxyl group concentration, the steam concentration in the sealing environment can be selected to produce a more uniform hydroxyl group concentration across the interface. Traces 1010 and 1030 in FIG. 10 and traces 1110 and 1130 of FIG. 11 show that gradients in the hydroxyl group concentration at the interface can be induced by changing the concentration of steam in the sealing environment.

### Example 5—Method of Forming a Sealed Glass Article from Glass Substrates of Varying Equilibrium Hydroxyl Group Concentration and at Varying Sealing Environments

In Example 5, sealed glass articles comprising a first glass substrate and a second glass substrate were produced. The first glass substrate and the second glass substrate had length (L), width (W), and height (H) dimensions of approximately 3.5 inches (L)×3.5 (W)×8 mm (H). A first interface surface of the first glass substrate perpendicular to the H and a second interface surface of the second glass substrate were positioned 1 mm apart with spacers at the corners of the first interface surface and the second interface surface to form a glass article precursor. The glass article precursor was positioned in a non-hermetically sealed MoSi₂ furnace. Steam and/or helium were introduced to the furnace such that a sealing environment of the furnace was maintained at a total pressure of 101.325 kPa (1 atmosphere). In embodiments where the scaling environment included both steam and helium, the helium and liquid water were pumped to a first heater operable to heat the mixture at 320° C. and then transfer the gas mixture to the furnace. In embodiments where the sealing environment included 100% steam, liquid water was pumped to the first heater to form steam and then the steam was transferred to the furnace. The sealing environment was configured to have a flow rate constant of 1 standard liter per minute with 1 exchange every 1 to 3 minutes.

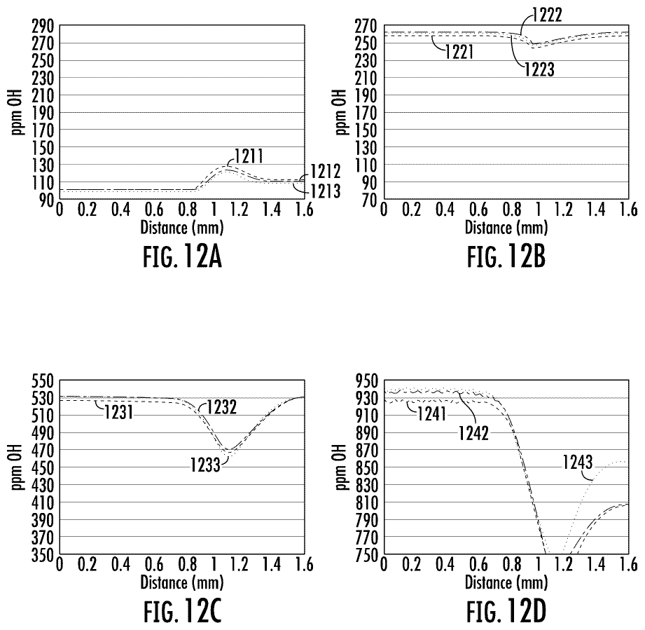

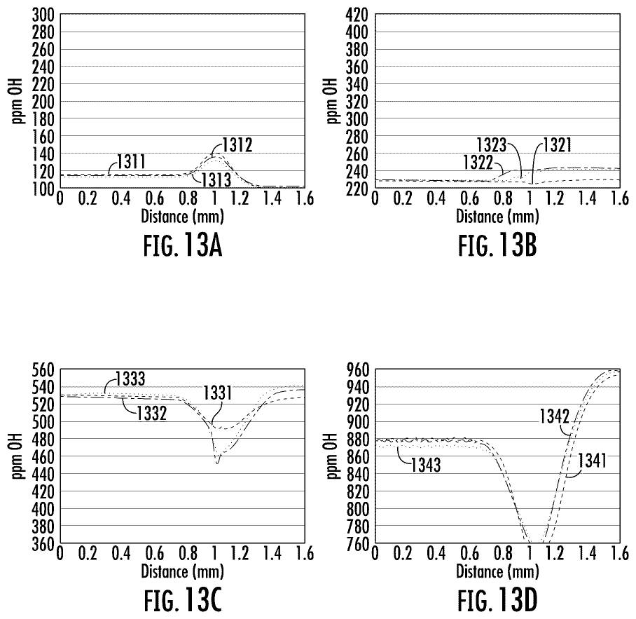

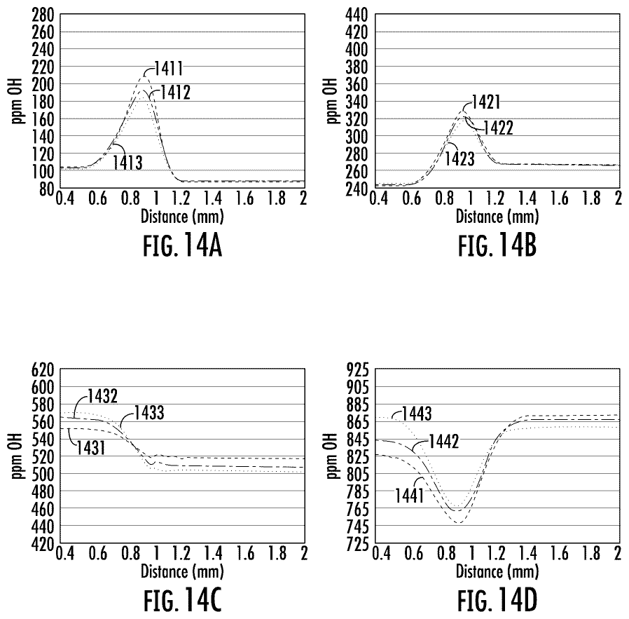

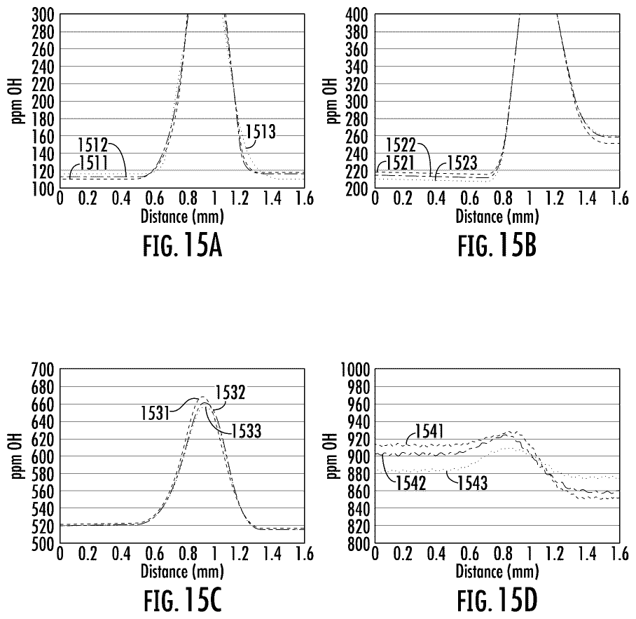

In Example 5, the sealing environment was varied with A) 100% helium, B) 5% steam/95% helium, C) 25% steam/75% helium, or D) 100% steam, based on the total volume of gases in the sealing environment, and the equilibrium hydroxyl group concentration of the first glass substrate and second glass substrate was varied with 1) 100 ppm, 2) 250 ppm, 3) 500 ppm, or 4) 900 ppm. The glass article precursors of Example 5 were heated according to the heating profile of trace 320 of FIG. 3 to form the glass articles. Once a temperature of 500° C. was reached, the steam was introduced into the furnace. The method conditions of each of the examples of Example 5 are summarized in Table 1. Additionally, FIG. 12A to FIG. 12D, FIG. 13A to FIG. 13D, 14-A-14D, and 15A-15D corresponding to the examples of Example 5 are included in Table 1. The hydroxyl group concentration of the glass articles along an axis perpendicular to the interface were measured. Further, each of FIG. 12A to FIG. 12D, FIG. 13A to FIG. 13D, FIG. 14A to FIG. 14D, and FIG. 15A to FIG. 15D include three traces corresponding to a measurement across the glass article perpendicular to the interface at the front-most region of the glass article relative to the position of the glass article in the furnace, at a middle-most region of the glass article, and at a back-most region of the glass article relative to the position of the glass article in the furnace, respectively. These traces and position are identified in Table 1. For instance, FIG. 12A includes traces 1211, 1212, and 1213 corresponding to a measurement at the front-most region of the glass article relative to the position of the glass article in the furnace, at a middle-most region of the glass article, and at a back-most region of the glass article relative to the position of the glass article in the furnace, respectively.

TABLE 1
Method Conditions of Example 5

| | | | | | | Difference of a |
|---|---|---|---|---|---|---|
| | | | | | | hydroxyl group |
| | Hydroxyl | | | | | concentration at the |
| | Group | | | | | interface and first |
| | Concentration | | | | | glass substrate of |
| | of bulk glass | Vol % | Vol % | | Trace and | less than or equal to |
| Example | (ppm) | Steam | Helium | FIG. | position | 30 ppm? |
| Ex. 5A-1 | 100 | 0 | 100 | 12A | 1211-front | No |
| | | | | | 1212- middle | |
| | | | | | 1213- back | |
| Ex. 5A-2 | 250 | 0 | 100 | 12B | 1221-front | Yes |
| | | | | | 1222- middle | |
| | | | | | 1223- back | |
| Ex. 5A-3 | 500 | 0 | 100 | 12C | 1231-front | No |
| | | | | | 1232- middle | |
| | | | | | 1233- back | |
| Ex. 5A-4 | 900 | 0 | 100 | 12D | 1241-front | No |
| | | | | | 1242- middle | |
| | | | | | 1243- back | |
| Ex. 5B-1 | 100 | 5 | 95 | 13A | 1311-front | No |
| | | | | | 1312- middle | |
| | | | | | 1313- back | |
| Ex. 5B-2 | 250 | 5 | 95 | 13B | 1321-front | Yes |
| | | | | | 1322- middle | |
| | | | | | 1323- back | |
| Ex. 5B-3 | 500 | 5 | 95 | 13C | 1331-front | No |
| | | | | | 1332- middle | |
| | | | | | 1333- back | |
| Ex. 5B-4 | 900 | 5 | 95 | 13D | 1341-front | No |
| | | | | | 1342- middle | |
| | | | | | 1343- back | |
| Ex. 5C-1 | 100 | 25 | 75 | 14A | 1411-front | No |
| | | | | | 1412- middle | |
| | | | | | 1413- back | |
| Ex. 5C-2 | 250 | 25 | 75 | 14B | 1421-front | No |
| | | | | | 1422- middle | |
| | | | | | 1423- back | |
| Ex. 5C-3 | 500 | 25 | 75 | 14C | 1431-front | Yes |
| | | | | | 1432- middle | |
| | | | | | 1433- back | |
| Ex. 5C-4 | 900 | 25 | 75 | 14D | 1441-front | No |
| | | | | | 1442- middle | |
| | | | | | 1443- back | |
| Ex. 5D-1 | 100 | 100 | 0 | 15A | 1511-front | No |
| | | | | | 1512- middle | |
| | | | | | 1513- back | |
| Ex. 5D-2 | 250 | 100 | 0 | 15B | 1521-front | No |
| | | | | | 1522- middle | |
| | | | | | 1523- back | |
| Ex. 5D-3 | 500 | 100 | 0 | 15C | 1531-front | No |
| | | | | | 1532- middle | |
| | | | | | 1533- back | |
| Ex. 5D-4 | 900 | 100 | 0 | 15D | 1541-front | No |
| | | | | | 1542- middle | |
| | | | | | 1543- back | |

### Example 5A—0% Steam/100% Helium

As shown in Table 1, and 12, Ex. 5A-2, which had glass substrates having a hydroxyl group concentration of about 250 ppm and a sealing environment of 100% helium resulted in a glass article having a difference of a hydroxyl group concentration at the interface and a hydroxyl group concentration of the glass substrate of about 20 ppm. Ex. 5A-1, Ex. 5A-3, and Ex. 5A-4 resulted in a difference of greater than 30 ppm.

### Example 5B—5% Steam/95% Helium

As shown in Table 1, and 13, Ex. 5B-2, which had glass substrates having a hydroxyl group concentration of about 250 ppm and a sealing environment of 5% steam and 95% helium resulted in a glass article having a difference of a hydroxyl group concentration at the interface and a hydroxyl group concentration of the glass substrate of about 5 ppm. Ex. 5B-1, Ex. 5B-3, and Ex. 5B-4 resulted in a difference of greater than 30 ppm.

### Example 5C—25% Steam/75% Helium

As shown in Table 1, and 14, Ex. 5C-3, which had glass substrates having a hydroxyl group concentration of about 500 ppm and a sealing environment of 25% steam and 75% helium resulted in a glass article having a difference of a hydroxyl group concentration at the interface and a hydroxyl group concentration of a glass substrate of about 5 ppm. Ex. 5C-1, Ex. 5C-2, and Ex. 5C-4 resulted in a difference of greater than 30 ppm.

### Example 5D—100% Steam/0% Helium

As shown in Table 1, and 15, each of Ex. 5D-1, Ex. 5D-2, Ex. 5D-3, and Ex. 5D-4, which had a sealing environment of 100% steam resulted in glass articles having a difference of a hydroxyl group concentration at the interface and a hydroxyl group concentration of a glass substrate of greater than 30 ppm.

As disclosed in the methods herein, the sealing environment and/or the temperature profile of the heating may be controlled during stack sealing two or more glass substrates at an interface, which may modify the hydroxyl group concentration at the interface to improve homogeneity of the interface relative to the two or more glass substrates prior to stack sealing.

### EXEMPLARY CLAIM SET

Exemplary Claim 1. A method of forming a glass article, the method comprising: positioning a first glass substrate and a second glass substrate with a first interface surface of the first glass substrate facing a second interface surface of the second glass substrate to produce a glass article precursor, wherein the first interface surface and the second interface surface are spaced apart by a distance greater than or equal to 0 mm and less than or equal to 5 mm; heating the glass article precursor in a sealing environment at a sealing temperature and for a time sufficient to stack seal the first glass substrate to the second glass substrate to form the glass article; wherein: the sealing environment comprises steam, an inert gas, or combinations thereof; subsequent to the heating, the second interface surface of the second glass substrate and the first interface surface of the first glass substrate are in direct contact with one another, wherein the direct contact between the first glass substrate and the second glass substrate establish an interface between the first glass substrate and the second glass substrate; and a peak-to-valley difference of a hydroxyl group concentration measured along a first line is less than or equal to 30 ppm; wherein: the first line is perpendicular to the interface and extends between a depth of the first glass substrate of a first distance from the interface and the interface; and the hydroxyl group concentration is measured along the first line at a spacing of less than or equal to 0.1 mm.

Exemplary Claim 2. A method of forming a glass article, the method comprising: positioning a first glass substrate and a second glass substrate with a first interface surface of the first glass substrate facing a second interface surface of the second glass substrate to produce a glass article precursor, wherein the first interface surface and the second interface surface are spaced apart by a distance greater than or equal to 0 mm and less than or equal to 5 mm; heating the glass article precursor in a sealing environment at a sealing temperature and for a time sufficient to stack seal the first glass substrate to the second glass substrate to form the glass article; wherein: the sealing environment comprises steam, an inert gas, or combinations thereof; subsequent to the heating, the second interface surface of the second glass substrate and the first interface surface of the first glass substrate are in direct contact with one another, wherein the direct contact between the first glass substrate and the second glass substrate establish an interface between the first glass substrate and the second glass substrate; and a birefringence of the glass article, as measured at the interface, is less than or equal to 50 nm/cm, less than or equal to 20 nm/cm, or less than or equal to 10 nm/cm.

Exemplary Claim 3. The method of Exemplary Claim 1 or Exemplary Claim 2, wherein a peak-to-valley difference of a hydroxyl group concentration measured along a second line is less than or equal to 30 ppm; wherein: the second line is perpendicular to the interface; the second line extends between a depth of the second glass substrate of a second distance from the interface and the interface; and the hydroxyl group concentration is measured along the second line at a spacing of less than or equal to 0.1 mm.

Exemplary Claim 4. The method of any one of Exemplary Claim 1 to Exemplary claim 3, wherein a peak-to-valley difference of a hydroxyl group concentration measured along a third line is less than or equal to 30 ppm; wherein: the third line is perpendicular to the interface; the third line extends between a depth of the first glass substrate of the first distance from the interface and a depth of the second glass substrate of a second distance from the interface; and the hydroxyl group concentration is measured along the third line at a spacing of less than or equal to 0.1 mm.

Exemplary Claim 5. The method of any one of Exemplary Claim 1 to Exemplary claim 4, wherein the first distance is greater than or equal to 0.5 mm and less than or equal to 5.0 mm.

Exemplary Claim 6. The method of any one of Exemplary Claim 3 to Exemplary claim 5, wherein the second distance is greater than or equal to 0.5 mm and less than or equal to 5.0 mm.

Exemplary Claim 7. The method of any one of Exemplary Claim 1 to Exemplary claim 6, wherein a peak-to-valley difference of a titania concentration measured along a fourth line is greater than or equal to 30 ppm; wherein: the fourth line is perpendicular to the interface; the fourth line extends between a depth of the first glass substrate of a fourth distance from the interface and the interface; and the titania concentration is measured along the fourth line at a spacing of less than or equal to 0.1 mm.

Exemplary Claim 8. The method of any one of Exemplary Claim 1 to Exemplary claim 7, wherein a peak-to-valley difference of a titania concentration measured along a fourth line is less than or equal to 700 ppm, less than or equal to 400 ppm, or less than or equal to 200 ppm; wherein: the fourth line is perpendicular to the interface; the fourth line extends between a depth of the first glass substrate of a fourth distance from the interface and the interface; and the titania concentration is measured along the fourth line at a spacing of less than or equal to 0.1 mm.

Exemplary Claim 9. The method of any one of Exemplary Claim 1 to Exemplary claim 8, wherein a peak-to-valley difference of a titania concentration measured along a fifth line is greater than or equal to 30 ppm; wherein: the fifth line is perpendicular to the interface; the fifth line extends between a depth of the second glass substrate of a fifth distance from the interface and the interface; and the titania concentration is measured along the fifth line at a spacing of less than or equal to 0.1 mm.

Exemplary Claim 10. The method of any one of Exemplary Claim 1 to Exemplary claim 9, wherein a peak-to-valley difference of a titania concentration measured along a fifth line is less than or equal to 700 ppm, less than or equal to 400 ppm, or less than or equal to 200 ppm; wherein: the fifth line is perpendicular to the interface; the fifth line extends between a depth of the second glass substrate of a fifth distance from the interface and the interface; and the titania concentration is measured along the fifth line at a spacing of less than or equal to 0.1 mm.

Exemplary Claim 11. The method of any one of Exemplary Claim 1 to Exemplary claim 10, wherein a peak-to-valley difference of a titania concentration measured along a sixth line is greater than or equal to 30 ppm; wherein: the sixth line is perpendicular to the interface; the sixth line extends between a depth of the first glass substrate of the fourth distance from the interface and a depth of the second glass substrate of the fifth distance from the interface; and the titania concentration is measured along the sixth line at a spacing of less than or equal to 0.1 mm.

Exemplary Claim 12. The method of any one of Exemplary Claim 1 to Exemplary claim 11, wherein a peak-to-valley difference of a titania concentration measured along a sixth line is less than or equal to 700 ppm, less than or equal to 400 ppm, or less than or equal to 200 ppm; wherein: the sixth line is perpendicular to the interface; the sixth line extends between a depth of the first glass substrate of the fourth distance from the interface and a depth of the second glass substrate of the fifth distance from the interface; and the titania concentration is measured along the sixth line at a spacing of less than or equal to 0.1 mm.

Exemplary Claim 13. The method of any one of Exemplary Claim 1 to Exemplary claim 12, wherein a region of the glass article defined between a depth of the first glass substrate of a fourth distance from the interface and a depth of the second glass substrate of a fifth distance from the interface has a peak-to-valley difference of the titania concentration of less than or equal to 700 ppm, less than or equal to 400 ppm, or less than or equal to 200 ppm, wherein the titania concentration is measured within the region at a spacing of less than or equal to 0.1 mm.

Exemplary Claim 14. The method of any one of Exemplary Claim 1 to Exemplary claim 13, wherein an absolute value of a difference of an average titania concentration at the interface and an average titania concentration at a depth of the second glass substrate of the fifth distance from the interface is greater than or equal to 30 ppm.

Exemplary Claim 15. The method of any one of Exemplary Claim 1 to Exemplary claim 14, wherein an absolute value of a difference of an average titania concentration at the interface and an average titania concentration at a depth of the first glass substrate of the fourth distance from the interface is less than or equal to 700 ppm, less than or equal to 400 ppm, or less than or equal to 200 ppm.

Exemplary Claim 16. The method of any one of Exemplary Claim 1 to Exemplary claim 15, wherein an absolute value of a difference of an average titania concentration at the interface and an average titania concentration at a depth of the second glass substrate of the fifth distance from the interface is less than or equal to 700 ppm, less than or equal to 400 ppm, or less than or equal to 200 ppm.

Exemplary Claim 17. The method of any one of Exemplary Claim 1 to Exemplary claim 16, wherein a peak-to-valley difference of the CTE slope measured along a seventh line is less than or equal to 0.1 ppb/K², as measured at 20° C.; wherein: the seventh line is perpendicular to the interface; the seventh line extends between a depth of the first glass substrate of a seventh distance from the interface and the interface; and the CTE slope is measured along the seventh line at a spacing of less than or equal to 0.1 mm.

Exemplary Claim 18. The method of any one of Exemplary Claim 1 to Exemplary claim 17, wherein a peak-to-valley difference of the CTE slope measured along a eighth line is less than or equal to 0.1 ppb/K², as measured at 20° C.; wherein: the eighth line is perpendicular to the interface; the eighth line extends between a depth of the second glass substrate of an eighth distance from the interface and the interface; and the CTE slope is measured along the eighth line at a spacing of less than or equal to 0.1 mm.

Exemplary Claim 19. The method of any one of Exemplary Claim 1 to Exemplary claim 18, wherein a peak-to-valley difference of the CTE slope measured along a ninth line is less than or equal to 0.1 ppb/K², as measured at 20° C.; wherein: the ninth line is perpendicular to the interface; the ninth line extends between a depth of the first glass substrate of a seventh distance from the interface and a depth of the second glass substrate of an eighth distance from the interface; and the CTE slope is measured along the ninth line at a spacing of less than or equal to 0.1 mm.

Exemplary Claim 20. The method of any one of Exemplary Claim 1 to Exemplary claim 19, wherein a region of the glass article defined between a depth of the first glass substrate of a seventh distance from the interface and a depth of the second glass substrate of a second distance from the interface has a peak-to-valley difference of the CTE slope of less than or equal to 0.1 ppb/K², wherein the CTE slope is measured within the region at a spacing of less than or equal to 0.1 mm and at 20° C.

Exemplary Claim 21. The method of any one of Exemplary Claim 1 to Exemplary claim 20, wherein an absolute value of a difference of a CTE slope at the interface and a CTE slope at a depth of the first glass substrate of a seventh distance from the interface is less than or equal to 0.1 ppb/K², as measured at 20° C.

Exemplary Claim 22. The method of any one of Exemplary Claim 1 to Exemplary claim 21, wherein an absolute value of a difference of a CTE slope at the interface and a CTE slope at a depth of the second glass substrate of a second distance from the interface is less than or equal to 0.1 ppb/K², as measured at 20° C.

Exemplary Claim 23. The method of any one of Exemplary Claim 1 to Exemplary claim 22, wherein an absolute value of a difference of a CTE slope at a depth of the first glass substrate of a seventh distance from the interface and a CTE slope at a depth of the second glass substrate of an eighth distance from the interface is less than or equal to 0.1 ppb/K², as measured at 20° C.

Exemplary Claim 24. The method of any one of Exemplary Claim 1 to Exemplary claim 23, wherein a peak-to-valley expansivity slope measured along a first line is less than or equal to 2.0 ppb/K², less than or equal to 1.0 ppb/K², or less than or equal to 0.5 ppb/K², as measured at 20° C.; wherein: the first line is perpendicular to the interface; the first line extends between a depth of the first glass substrate of the first distance from the interface and the interface; and the expansivity slope is measured along the first line at a spacing of less than or equal to 0.1 mm.

Exemplary Claim 25. The method of any one of Exemplary Claim 1 to Exemplary claim 24, wherein a peak-to-valley expansivity slope measured along a second line is less than or equal to 2.0 ppb/K², less than or equal to 1.0 ppb/K², or less than or equal to 0.5 ppb/K², as measured at 20° C.; wherein: the second line is perpendicular to the interface; the second line extends between a depth of the second glass substrate of the second distance from the interface and the interface; and the expansivity slope is measured along the second line at a spacing of less than or equal to 0.1 mm.

Exemplary Claim 26. The method of any one of Exemplary Claim 1 to Exemplary claim 25, wherein a peak-to-valley expansivity slope measured along a tenth line is less than or equal to 2.0 ppb/K², less than or equal to 1.0 ppb/K², or less than or equal to 0.5 ppb/K², as measured at 20° C.; wherein: the tenth line is perpendicular to the interface; the tenth line extends between a depth of the first glass substrate of a tenth distance from the interface and a depth of the second glass substrate of an eleventh distance from the interface; and the expansivity slope is measured along the tenth line at a spacing of less than or equal to 0.1 mm.

Exemplary Claim 27. The method of any one of Exemplary Claim 1 to Exemplary claim 26, wherein an absolute value of a difference of an expansivity slope at the interface and an expansivity slope at a depth of the first glass substrate of a tenth distance from the interface is less than or equal to 2.0 ppb/K², less than or equal to 1.0 ppb/K², or less than or equal to 0.5 ppb/K², as measured at 20° C.

Exemplary Claim 28. The method of any one of Exemplary Claim 1 to Exemplary claim 27, wherein an absolute value of a difference of an expansivity slope at the interface and an expansivity slope at a depth of the second glass substrate of an eleventh from the interface is less than or equal to 2.0 ppb/K², less than or equal to 1.0 ppb/K², or less than or equal to 0.5 ppb/K², as measured at 20° C.

Exemplary Claim 29. The method of any one of Exemplary Claim 1 to Exemplary claim 28, wherein an absolute value of a difference of an expansivity slope at the interface and an expansivity slope at a depth of the first glass substrate of a tenth distance from the interface is greater than or equal to 0.01 ppb/K², as measured at 20° C.

Exemplary Claim 30. The method of any one of Exemplary Claim 1 to Exemplary claim 29, wherein an absolute value of a difference of an expansivity slope at the interface and an expansivity at a depth of the second glass substrate of an eleventh distance from the interface is greater than or equal to 0.01 ppb/K², as measured at 20° C.

Exemplary Claim 31. The method of any one of Exemplary Claim 1 to Exemplary claim 30, wherein a region of the glass article defined between a depth of the first glass substrate of a tenth distance from the interface and a depth of the second glass substrate of an eleventh distance from the interface has a peak-to-valley expansivity slope of less than or equal to 2.0 ppb/K², less than or equal to 1.0 ppb/K², or less than or equal to 0.5 ppb/K², wherein the expansivity slope is measured within the region at a spacing of less than or equal to 0.1 mm and at 20° C.

Exemplary Claim 32. The method of any one of Exemplary Claim 1 to Exemplary claim 31, wherein an absolute value of a difference of an expansivity slope at a depth of the first glass substrate of a tenth distance from the interface and an expansivity slope at a depth of the second glass substrate of an eleventh distance from the interface is less than or equal to 2.0 ppb/K², less than or equal to 1.0 ppb/K², or less than or equal to 0.5 ppb/K², as measured at 20° C.

Exemplary Claim 33. The method of any one of Exemplary Claim 1 to Exemplary claim 32, wherein a region of the glass article defined between a depth of the first glass substrate of a tenth distance from the interface and a depth of the second glass substrate of an eleventh distance from the interface has a birefringence of less than or equal to 50 nm/cm, less than or equal to 20 nm/cm, or less than or equal to 10 nm/cm², wherein the birefringence is measured within the region at a spacing of less than or equal to 0.1 mm.

Exemplary Claim 34. The method of any one of Exemplary Claim 1 to Exemplary claim 33, wherein a birefringence of the glass article, as measured along a thirteenth line is less than or equal to 50 nm/cm, less than or equal to 20 nm/cm, or less than or equal to 10 nm/cm; wherein: the thirteenth line is perpendicular to the interface and extends between a depth of the first glass substrate of a thirteenth distance from the interface and the interface; and the birefringence is measured along the thirteenth line at a spacing of less than or equal to 0.1 mm.

Exemplary Claim 35. The method of any one of Exemplary Claim 1 to Exemplary claim 34, wherein a birefringence of the glass article, as measured along a fourteenth line is less than or equal to 50 nm/cm, less than or equal to 20 nm/cm, or less than or equal to 10 nm/cm; wherein: the fourteenth line is perpendicular to the interface and extends between a depth of the second glass substrate of a fourteenth distance from the interface and the interface; and the birefringence is measured along the fourteenth line at a spacing of less than or equal to 0.1 mm.

Exemplary Claim 36. The method of any one of Exemplary Claim 1 to Exemplary claim 35, wherein a birefringence of the glass article, as measured along a fifteenth line is less than or equal to 50 nm/cm, less than or equal to 20 nm/cm, or less than or equal to 10 nm/cm; wherein: the fifteenth line is perpendicular to the interface and extends between a depth of the first glass substrate of a thirteenth distance from the interface and a depth of the second glass substrate of a thirteenth distance from the interface; and the birefringence is measured along the fifteenth line at a spacing of less than or equal to 0.1 mm.

Exemplary Claim 37. The method of any one of Exemplary Claim 1 to Exemplary claim 36, wherein the first interface surface and the second interface surface are spaced apart by a distance greater than 0 mm and less than or equal to 3 mm.

Exemplary Claim 38. The method of any one of Exemplary Claim 1 to Exemplary claim 37, wherein the first interface surface and the second interface surface are spaced apart by a distance greater than or equal to 0.5 mm and less than or equal to 1.5 mm.

Exemplary Claim 39. The method of any one of Exemplary Claim 1 to Exemplary claim 38, wherein the heating comprises maintaining the glass article precursor at the sealing temperature of from greater than or equal to 500° C. to less than or equal to 2,000° C.

Exemplary Claim 40. The method of any one of Exemplary Claim 1 to Exemplary claim 39, wherein the heating comprises exposing the glass article precursor to the sealing environment at the sealing temperature for a time of greater than or equal to 0.5 hour to less than or equal to 48 hours.

Exemplary Claim 41. The method of any one of Exemplary Claim 1 to Exemplary claim 40, wherein the heating comprises increasing a temperature of the glass article precursor to the sealing temperature at a temperature ramping rate for a first duration of time, maintaining the glass article precursor at the sealing temperature for a second duration of time, and decreasing the temperature of the glass article precursor at a cooling rate for a third duration of time.

Exemplary Claim 42. The method of any one of Exemplary Claim 1 to Exemplary claim 41, wherein the heating comprises increasing the sealing temperature at a rate of from 10° C. per hour to 1,000° C. per hour for the first duration of time.

Exemplary Claim 43. The method of any one of Exemplary Claim 1 to Exemplary claim 42, wherein after the second duration of time, the heating comprises reducing the sealing temperature at a rate of from 30° C. per hour to 1000° C. per hour for the third duration of time.

Exemplary Claim 44. The method of any one of Exemplary Claim 1 to Exemplary claim 43, wherein the heating comprises increasing a temperature of the glass article precursor to a first hold temperature, maintaining the glass article precursor at the first hold temperature for a first hold time, increasing the temperature of the glass article precursor to the scaling temperature, maintaining the glass article precursor at the sealing temperature for a second hold time, and decreasing the temperature of the glass article precursor.

Exemplary Claim 45. The method of any one of Exemplary Claim 1 to Exemplary claim 44, wherein the heating comprises: exposing the glass article precursor to the sealing environment, wherein the sealing environment comprises steam; and laser treating the glass article precursor.

Exemplary Claim 46. The method of Exemplary Claim 45, wherein the laser treating increases at least a portion of the first glass substrate and a portion of the second glass substrate to a temperature of greater than or equal to 1,400° C., greater than or equal to 1,600° C., greater than or equal to 1,800° C., or greater than or equal to 2,000° C.

Exemplary Claim 47. The method of either one of Exemplary Claim 45 or Exemplary claim 46, wherein the laser treating is operated for a time of less than or equal to 20 seconds.

Exemplary Claim 48. The method of any one of Exemplary Claim 1 to Exemplary claim 47, wherein the heating comprises introducing steam to the sealing environment to achieve a partial pressure of steam within the sealing environment of from greater than or equal to 0 kilopascals (kPa) to less than or equal to 1,000 kPa.

Exemplary Claim 49. The method of any one of Exemplary Claim 1 to Exemplary claim 48, wherein the sealing environment comprises greater than or equal to 5 volume percent (vol. %), greater than or equal to 10 vol. %, greater than or equal to 25 vol. %, greater than or equal to 50 vol. %, greater than or equal to 60 vol. %, greater than or equal to 70 vol. %, greater than or equal to 80 vol. %, greater than or equal to 90 vol. %, greater than or equal to 95 vol. %, greater than or equal to 99 vol. %, or 100 vol. % steam, based on a total volume of gases in the sealing environment.

Exemplary Claim 50. The method of any one of Exemplary Claim 1 to Exemplary claim 49, wherein the sealing environment comprises a partial pressure of oxygen of from greater than or equal to 1.0 kilopascals (kPa) to less than or equal to 100 kPa.

Exemplary Claim 51. The method of any one of Exemplary Claim 1 to Exemplary claim 50, wherein an absolute value of a difference of an average titania concentration at a depth of the first glass substrate of the first distance from the interface and an average titania concentration at a depth of the second glass substrate of a second distance from the interface is less than or equal to 0.15 weight percent (wt. %).

Exemplary Claim 52. The method of any one of Exemplary Claim 1 to Exemplary claim 51, further comprising, during heating maintaining a constant partial pressure of steam in the sealing environment and adjusting a temperature profile of the heating to maintain the absolute value of the difference of the hydroxyl group concentration at the interface and the hydroxyl group concentration at a depth of the first glass substrate of the first distance from the interface less than or equal to 30 ppm.

Exemplary Claim 53. The method of Exemplary Claim 52, wherein adjusting a temperature profile of the heating comprises adjusting one or more of the sealing temperature, a temperature ramping rate, a duration of maintaining the glass article precursor at the sealing temperature, a cooling rate, or combinations of these.

Exemplary Claim 54. The method of any one of Exemplary Claim 1 to Exemplary claim 53, further comprising, during heating, adjusting a partial pressure of steam in the sealing environment to maintain the absolute value of the difference of the hydroxyl group concentration at the interface and the hydroxyl group concentration at a depth of the first glass substrate of the first distance from the interface less than or equal to 30 ppm.

Exemplary Claim 55. The method of Exemplary Claim 54, wherein adjusting the partial pressure of steam in the sealing environment comprises increasing or decreasing a flow rate of steam into the sealing environment.

Exemplary Claim 56. The method of any one of Exemplary Claim 1 to Exemplary claim 55, wherein: a first portion of the first glass substrate has a first height, a first length, a first width, and a first cross-section, wherein the first cross-section is perpendicular to a direction of the first height of the first portion of the first glass substrate; a second portion of the second glass substrate has a second height, a second length, a second width, and a second cross-section, wherein the second cross-section is perpendicular to a direction of the second height of the second portion of the second glass substrate; a third portion of the interface has a third height, a third length, a third width, and a third cross-section, wherein the third cross-section is perpendicular to a direction of the third height of the third portion of the interface; the first cross-section is parallel to the third cross-section, and the second cross-section is parallel to the third cross-section; a surface of the first cross-section proximal to the third cross-section is positioned a first distance from a surface of the third cross-section proximal to the first cross-section; a surface of the second cross-section proximal to the third cross-section is positioned a second distance from a surface of the third cross-section proximal to the second cross-section; the first portion of the first glass substrate has an average first hydroxyl group concentration, as measured at the first cross-section; the second portion of the second glass substrate has an average second hydroxyl group concentration, as measured at the second cross-section; the third portion of the interface has an average interface hydroxyl group concentration, as measured at the third cross-section; and an absolute value of a difference of a hydroxyl group concentration between the average first hydroxyl group concentration and the average interface hydroxyl group concentration is less than or equal to 30 parts per million (ppm), an absolute value of a difference of a hydroxyl group concentration between the average second hydroxyl group concentration and the average interface hydroxyl group concentration is less than or equal to 30 ppm, or both.

Exemplary Claim 57. A glass article comprising a first glass substrate and a second glass substrate stack sealed to the first glass substrate at an interface, wherein: a peak-to-valley difference of a hydroxyl group concentration measured along a first line is less than or equal to 30 ppm; wherein: the first line is perpendicular to the interface and extends between a depth of the first glass substrate of a first distance from the interface and the interface; and the hydroxyl group concentration is measured along the first line at a spacing of less than or equal to 0.1 mm.

Exemplary Claim 58. A glass article comprising a first glass substrate and a second glass substrate stack sealed to the first glass substrate at an interface, wherein a birefringence of the glass article, as measured at the interface, is less than or equal to 50 nm/cm, less than or equal to 20 nm/cm, or less than or equal to 10 nm/cm.

Exemplary Claim 59. The glass article of Exemplary Claim 57 or Exemplary Claim 58, wherein the hydroxyl group concentration at the interface and the hydroxyl group concentration at a depth of the first glass substrate of the first distance from the interface are greater than 0 ppm and less than or equal to 1,500 ppm.

Exemplary Claim 60. The glass article of any one of Exemplary Claim 57 to Exemplary Claim 59, wherein the hydroxyl group concentration at a depth of the second glass substrate of a second distance from the interface are greater than 0 ppm and less than or equal to 1,500 ppm.

Exemplary Claim 61. The glass article of any one of Exemplary Claim 57 to Exemplary Claim 60, wherein the hydroxyl group concentration at the interface and the hydroxyl group concentration at a depth of the first glass substrate of the first distance from the interface are each greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm.

Exemplary Claim 62. The glass article of any one of Exemplary Claim 57 to Exemplary Claim 61, wherein the hydroxyl group concentration at the interface and the hydroxyl group concentration at a depth of the first glass substrate of the first distance from the interface are each greater than or equal to 1,000 ppm and less than or equal to 1,400 ppm.

Exemplary Claim 63. The glass article of any one of Exemplary Claim 57 to Exemplary Claim 62, wherein an absolute value of a difference of a titania concentration at a depth of the first glass substrate of the first distance from the interface and a titania concentration at a depth of the second glass substrate of a second distance from the interface is less than or equal to 0.15 weight percent (wt. %).

Exemplary Claim 64. The glass article of any one of Exemplary Claim 57 to Exemplary Claim 63, wherein the glass article has an average thickness of greater than or equal to 20 mm, greater than or equal to 50 mm, or greater than or equal to 100 mm, as measured perpendicular to the interface.

Exemplary Claim 65. The glass article of any one of Exemplary Claim 57 to Exemplary Claim 64, wherein the first glass substrate has an average thickness of greater than or equal to 10 mm, greater than or equal to 25 mm, or greater than or equal to 50 mm, as measured perpendicular to the interface.

Exemplary Claim 66. The glass article of any one of Exemplary Claim 57 to Exemplary Claim 65, wherein the second glass substrate has an average thickness of greater than or equal to 10 mm, greater than or equal to 25 mm, or greater than or equal to 50 mm, as measured perpendicular to the interface.

Exemplary Claim 67. The glass article of any one of Exemplary Claim 57 to Exemplary Claim 66, wherein the glass article has a mass of greater than 1 kilogram, greater than 10 kilograms, or greater than 25 kilograms.

Exemplary Claim 68. The glass article of any one of Exemplary Claim 57 to Exemplary Claim 67, wherein: the first glass substrate comprises a first interface surface; and the second glass substrate is disposed onto the first glass substrate such that a second interface surface of the second glass substrate and the first interface surface of the first glass substrate are in direct contact with one another, wherein the direct contact between the first glass substrate and the second glass substrate establish the interface between the first glass substrate and the second glass substrate.

Exemplary Claim 69. The glass article of any one of Exemplary Claim 57 to Exemplary Claim 68, wherein the first distance is greater than or equal to 0.5 mm and less than or equal to 5.0 mm.

Exemplary Claim 70. The glass article of any one of Exemplary Claim 57 to Exemplary Claim 69, wherein the second distance is greater than or equal to 0.5 mm and less than or equal to 5.0 mm.

Exemplary Claim 71. The glass article of any one of Exemplary Claim 57 to Exemplary Claim 70, wherein a region of the glass article defined between a depth of the first glass substrate of the first distance from the interface and a depth of the second glass substrate of a second distance from the interface has a peak-to-valley hydroxyl group concentration of less than or equal to 30 ppm, wherein the hydroxyl group concentration is measured within the region at a spacing of less than or equal to 0.1 mm.

Exemplary Claim 72. The glass article of any one of Exemplary Claim 57 to Exemplary Claim 71, wherein a peak-to-valley difference of a hydroxyl group concentration measured along a second line is less than or equal to 30 ppm; wherein: the second line is perpendicular to the interface; the second line extends between a depth of the second glass substrate of a second distance from the interface and the interface; and the hydroxyl group concentration is measured along the second line at a spacing of less than or equal to 0.1 mm.

Exemplary Claim 73. The glass article of any one of Exemplary Claim 57 to Exemplary Claim 72, wherein a peak-to-valley difference of a hydroxyl group concentration measured along a third line is less than or equal to 30 ppm; wherein: the third line is perpendicular to the interface; the third line extends between a depth of the first glass substrate of the first distance from the interface and a depth of the second glass substrate of a second distance from the interface; and the hydroxyl group concentration is measured along the third line at a spacing of less than or equal to 0.1 mm.

Exemplary Claim 74. The glass article of any one of Exemplary Claim 57 to Exemplary Claim 73, wherein a peak-to-valley difference of a titania concentration measured along a fourth line is greater than or equal to 30 ppm; wherein: the fourth line is perpendicular to the interface; the fourth line extends between a depth of the first glass substrate of a fourth distance from the interface and the interface; and the titania concentration is measured along the fourth line at a spacing of less than or equal to 0.1 mm.

Exemplary Claim 75. The glass article of any one of Exemplary Claim 57 to Exemplary Claim 74, wherein a peak-to-valley difference of a titania concentration measured along a fourth line is less than or equal to 700 ppm, less than or equal to 400 ppm, or less than or equal to 200 ppm; wherein: the fourth line is perpendicular to the interface; the fourth line extends between a depth of the first glass substrate of a fourth distance from the interface and the interface; and the titania concentration is measured along the fourth line at a spacing of less than or equal to 0.1 mm.

Exemplary Claim 76. The glass article of any one of Exemplary Claim 57 to Exemplary Claim 75, wherein a peak-to-valley difference of a titania concentration measured along a fifth line is greater than or equal to 30 ppm; wherein: the fifth line is perpendicular to the interface; the fifth line extends between a depth of the second glass substrate of a fifth distance from the interface and the interface; and the titania concentration is measured along the fifth line at a spacing of less than or equal to 0.1 mm.

Exemplary Claim 77. The glass article of any one of Exemplary Claim 57 to Exemplary Claim 76, wherein a peak-to-valley difference of a titania concentration measured along a fifth line is less than or equal to 700 ppm, less than or equal to 400 ppm, or less than or equal to 200 ppm; wherein: the fifth line is perpendicular to the interface; the fifth line extends between a depth of the second glass substrate of a fifth distance from the interface and the interface; and the titania concentration is measured along the fifth line at a spacing of less than or equal to 0.1 mm.

Exemplary Claim 78. The glass article of any one of Exemplary Claim 57 to Exemplary Claim 77, wherein a peak-to-valley difference of a titania concentration measured along a sixth line is greater than or equal to 30 ppm; wherein: the sixth line is perpendicular to the interface; the sixth line extends between a depth of the first glass substrate of a fourth distance from the interface and a depth of the second glass substrate of a fifth distance from the interface; and the titania concentration is measured along the sixth line at a spacing of less than or equal to 0.1 mm.

Exemplary Claim 79. The glass article of any one of Exemplary Claim 57 to Exemplary Claim 78, wherein a peak-to-valley difference of a titania concentration measured along a sixth line is less than or equal to 700 ppm, less than or equal to 400 ppm, or less than or equal to 200 ppm; wherein: the sixth line is perpendicular to the interface; the sixth line extends between a depth of the first glass substrate of the first distance from the interface and a depth of the second glass substrate of a fifth distance from the interface; and the titania concentration is measured along the sixth line at a spacing of less than or equal to 0.1 mm.

Exemplary Claim 80. The glass article of any one of Exemplary Claim 57 to Exemplary Claim 79, wherein a region of the glass article defined between a depth of the first glass substrate of a fourth distance from the interface and a depth of the second glass substrate of a fifth distance from the interface has a peak-to-valley difference of the titania concentration of less than or equal to 700 ppm, less than or equal to 400 ppm, or less than or equal to 200 ppm, wherein the titania concentration is measured within the region at a spacing of less than or equal to 0.1 mm.

Exemplary Claim 81. The glass article of any one of Exemplary Claim 57 to Exemplary Claim 80, wherein an absolute value of a difference of an average titania concentration at the interface and an average titania concentration at a depth of the first glass substrate of a fourth distance from the interface is less than or equal to 700 ppm, less than or equal to 400 ppm, or less than or equal to 200 ppm.

Exemplary Claim 82. The glass article of any one of Exemplary Claim 57 to Exemplary Claim 81, wherein an absolute value of a difference of an average titania concentration at the interface and an average titania concentration at a depth of the second glass substrate of a fifth distance from the interface is less than or equal to 700 ppm, less than or equal to 400 ppm, or less than or equal to 200 ppm.

Exemplary Claim 83. The glass article of any one of Exemplary Claim 57 to Exemplary Claim 82, wherein a peak-to-valley difference of the CTE slope measured along a seventh line is less than or equal to 0.1 ppb/K², as measured at 20° C.; wherein: the seventh line is perpendicular to the interface; the seventh line extends between a depth of the first glass substrate of a seventh distance from the interface and the interface; and the CTE slope is measured along the seventh line at a spacing of less than or equal to 0.1 mm.

Exemplary Claim 84. The glass article of any one of Exemplary Claim 57 to Exemplary Claim 83, wherein a peak-to-valley difference of the CTE slope measured along an eighth line is less than or equal to 0.1 ppb/K², as measured at 20° C.; wherein: the eighth line is perpendicular to the interface; the eighth line extends between a depth of the second glass substrate of an eighth distance from the interface and the interface; and the CTE slope is measured along the eighth line at a spacing of less than or equal to 0.1 mm.

Exemplary Claim 85. The glass article of any one of Exemplary Claim 57 to Exemplary Claim 84, wherein a peak-to-valley difference of the CTE slope measured along a ninth line is less than or equal to 0.1 ppb/K², as measured at 20° C.; wherein: the ninth line is perpendicular to the interface; the ninth line extends between a depth of the first glass substrate of a seventh distance from the interface and a depth of the second glass substrate of an eighth distance from the interface; and the CTE slope is measured along the ninth line at a spacing of less than or equal to 0.1 mm.

Exemplary Claim 86. The glass article of any one of Exemplary Claim 57 to Exemplary Claim 85, wherein a region of the glass article defined between a depth of the first glass substrate of a seventh distance from the interface and a depth of the second glass substrate of an eighth distance from the interface has a peak-to-valley difference of the CTE slope of less than or equal to 0.1 ppb/K², wherein the CTE slope is measured within the region at a spacing of less than or equal to 0.1 mm and at 20° C.

Exemplary Claim 87. The glass article of any one of Exemplary Claim 57 to Exemplary Claim 86, wherein an absolute value of a difference of a CTE slope at the interface and a CTE slope at a depth of the first glass substrate of a seventh distance from the interface is less than or equal to 0.1 ppb/K², as measured at 20° C.

Exemplary Claim 88. The glass article of any one of Exemplary Claim 57 to Exemplary Claim 87, wherein an absolute value of a difference of a CTE slope at the interface and a CTE slope at a depth of the second glass substrate of an eighth distance from the interface is less than or equal to 0.1 ppb/K², as measured at 20° C.

Exemplary Claim 89. The glass article of any one of Exemplary Claim 57 to Exemplary Claim 88, wherein an absolute value of a difference of a CTE slope at a depth of the first glass substrate of a seventh distance from the interface and a CTE slope at a depth of the second glass substrate of an eighth distance from the interface is less than or equal to 0.1 ppb/K², as measured at 20° C.

Exemplary Claim 90. The glass article of any one of Exemplary Claim 57 to Exemplary Claim 89, wherein a peak-to-valley expansivity slope measured along a tenth line is less than or equal to 2.0 ppb/K², less than or equal to 1.0 ppb/K², or less than or equal to 0.5 ppb/K², as measured at 20° C.; wherein: the tenth line is perpendicular to the interface; the tenth line extends between a depth of the first glass substrate of a tenth distance from the interface and the interface; and the expansivity slope is measured along the tenth line at a spacing of less than or equal to 0.1 mm.

Exemplary Claim 91. The glass article of any one of Exemplary Claim 57 to Exemplary Claim 90, wherein a peak-to-valley expansivity slope measured along an eleventh line is less than or equal to 2.0 ppb/K², less than or equal to 1.0 ppb/K², or less than or equal to 0.5 ppb/K², as measured at 20° C.; wherein: the eleventh line is perpendicular to the interface; the eleventh line extends between a depth of the second glass substrate of an eleventh distance from the interface and the interface; and the expansivity slope is measured along the eleventh line at a spacing of less than or equal to 0.1 mm.

Exemplary Claim 92. The glass article of any one of Exemplary Claim 57 to Exemplary Claim 91, wherein a peak-to-valley expansivity slope measured along a twelfth line is less than or equal to 2.0 ppb/K², less than or equal to 1.0 ppb/K², or less than or equal to 0.5 ppb/K², as measured at 20° C.; wherein: the twelfth line is perpendicular to the interface; the twelfth line extends between a depth of the first glass substrate of a tenth distance from the interface and a depth of the second glass substrate of an eleventh distance from the interface; and the expansivity slope is measured along the twelfth line at a spacing of less than or equal to 0.1 mm.

Exemplary Claim 93. The glass article of any one of Exemplary Claim 57 to Exemplary Claim 92, wherein an absolute value of a difference of an expansivity slope at the interface and an expansivity slope at a depth of the first glass substrate of a tenth distance from the interface is less than or equal to 2.0 ppb/K², less than or equal to 1.0 ppb/K², or less than or equal to 0.5 ppb/K², as measured at 20° C.

Exemplary Claim 94. The glass article of any one of Exemplary Claim 57 to Exemplary Claim 93, wherein an absolute value of a difference of an expansivity slope at the interface and an expansivity slope at a depth of the second glass substrate of an eleventh distance from the interface is less than or equal to 2.0 ppb/K², less than or equal to 1.0 ppb/K², or less than or equal to 0.5 ppb/K², as measured at 20° C.

Exemplary Claim 95. The glass article of any one of Exemplary Claim 57 to Exemplary Claim 94, wherein an absolute value of a difference of an expansivity slope at the interface and an expansivity slope at a depth of the first glass substrate of a tenth distance from the interface is greater than or equal to 0.01 ppb/K², as measured at 20° C.

Exemplary Claim 96. The glass article of any one of Exemplary Claim 57 to Exemplary Claim 95, wherein an absolute value of a difference of an expansivity slope at the interface and an expansivity at a depth of the second glass substrate of an eleventh distance from the interface is greater than or equal to 0.01 ppb/K², as measured at 20° C.

Exemplary Claim 97. The glass article of any one of Exemplary Claim 57 to Exemplary Claim 96, wherein a region of the glass article defined between a depth of the first glass substrate of distance tenth distance from the interface and a depth of the second glass substrate of an eleventh distance from the interface has a peak-to-valley expansivity slope of less than or equal to 2.0 ppb/K², less than or equal to 1.0 ppb/K², or less than or equal to 0.5 ppb/K², wherein the expansivity slope is measured within the region at a spacing of less than or equal to 0.1 mm and at 20° C.

Exemplary Claim 98. The glass article of any one of Exemplary Claim 57 to Exemplary Claim 97, wherein an absolute value of a difference of an expansivity slope at a depth of the first glass substrate of a tenth distance from the interface and an expansivity slope at a depth of the second glass substrate of an eleventh from the interface is less than or equal to 2.0 ppb/K², less than or equal to 1.0 ppb/K², or less than or equal to 0.5 ppb/K², as measured at 20° C.

Exemplary Claim 99. The glass article of any one of Exemplary Claim 57 to Exemplary Claim 98, wherein a region of the glass article defined between a depth of the first glass substrate of a thirteenth distance from the interface and a depth of the second glass substrate of a fourteenth distance from the interface has a birefringence of less than or equal to 50 nm/cm, less than or equal to 20 nm/cm, or less than or equal to 10 nm/cm², wherein the birefringence is measured within the region at a spacing of less than or equal to 0.1 mm.

Exemplary Claim 100. The glass article of any one of Exemplary Claim 57 to Exemplary Claim 99, wherein a birefringence of the glass article, as measured along a thirteenth line is less than or equal to 50 nm/cm, less than or equal to 20 nm/cm, or less than or equal to 10 nm/cm; wherein: the thirteenth line is perpendicular to the interface and extends between a depth of the first glass substrate of a thirteenth distance from the interface and the interface; and the birefringence is measured along the thirteenth line at a spacing of less than or equal to 0.1 mm.

Exemplary Claim 101. The glass article of any one of Exemplary Claim 57 to Exemplary Claim 100, wherein a birefringence of the glass article, as measured along a fourteenth line is less than or equal to 50 nm/cm, less than or equal to 20 nm/cm, or less than or equal to 10 nm/cm; wherein: the fourteenth line is perpendicular to the interface and extends between a depth of the second glass substrate of a fourteenth distance from the interface and the interface; and the birefringence is measured along the fourteenth line at a spacing of less than or equal to 0.1 mm.

Exemplary Claim 102. The glass article of any one of Exemplary Claim 57 to Exemplary Claim 101, wherein a birefringence of the glass article, as measured along a fifteenth line is less than or equal to 50 nm/cm, less than or equal to 20 nm/cm, or less than or equal to 10 nm/cm; wherein: the fifteenth line is perpendicular to the interface and extends between a depth of the first glass substrate of a thirteenth distance from the interface and a depth of the second glass substrate of a fourteenth distance from the interface; and the birefringence is measured along the fifteenth line at a spacing of less than or equal to 0.1 mm.

Exemplary Claim 103. The glass article of any one of Exemplary Claim 57 to Exemplary Claim 102, wherein: a first portion of the first glass substrate has a first height, a first length, a first width, and a first cross-section, wherein the first cross-section is perpendicular to a direction of the first height of the first portion of the first glass substrate; a second portion of the second glass substrate has a second height, a second length, a second width, and a second cross-section, wherein the second cross-section is perpendicular to a direction of the second height of the second portion of the second glass substrate; a third portion of the interface has a third height, a third length, a third width, and a third cross-section, wherein the third cross-section is perpendicular to a direction of the third height of the third portion of the interface; the first cross-section is parallel to the third cross-section, and the second cross-section is parallel to the third cross-section; a surface of the first cross-section proximal to the third cross-section is positioned a first distance from a surface of the third cross-section proximal to the first cross-section; a surface of the second cross-section proximal to the third cross-section is positioned a second distance from a surface of the third cross-section proximal to the second cross-section; the first portion of the first glass substrate has an average first hydroxyl group concentration, as measured at the first cross-section; the second portion of the second glass substrate has an average second hydroxyl group concentration, as measured at the second cross-section; the third portion of the interface has an average interface hydroxyl group concentration, as measured at the third cross-section; and an absolute value of a difference of a hydroxyl group concentration between the average first hydroxyl group concentration and the average interface hydroxyl group concentration is less than or equal to 30 parts per million (ppm), an absolute value of a difference of a hydroxyl group concentration between the average second hydroxyl group concentration and the average interface hydroxyl group concentration is less than or equal to 30 ppm, or both.

Exemplary Claim 104. The glass article of Exemplary Claim 103, wherein: the first portion of the first glass substrate has an average first titania concentration, as measured at the first cross-section; the second portion of the second glass substrate has an average second titania concentration, as measured at the second cross-section; the third portion of the interface has an average interface titania concentration, as measured at the third cross-section; an absolute value of a difference of a titania concentration between the average first titania concentration and the average interface titania concentration is greater than or equal to 30 ppm, an absolute value of a difference of a titania concentration between the average second titania concentration and the average interface titania concentration is greater than or equal to 30 ppm, or both.

Exemplary Claim 105. The glass article of either one of Exemplary Claim 103 or Exemplary Claim 104, wherein the first glass substrate has an average thickness of greater than or equal to 10 mm, greater than or equal to 25 mm, or greater than or equal to 50 mm, as measured perpendicular to the first cross-section.

Exemplary Claim 106. The glass article of any one of Exemplary Claim 103 to Exemplary Claim 105, wherein the second glass substrate has an average thickness of greater than or equal to 10 mm, greater than or equal to 25 mm, or greater than or equal to 50 mm, as measured perpendicular to the second cross-section.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method of forming a glass article, the method comprising:
positioning a first glass substrate and a second glass substrate with a first interface surface of the first glass substrate facing a second interface surface of the second glass substrate to produce a glass article precursor, wherein the first interface surface and the second interface surface are spaced apart by a distance greater than or equal to 0 mm and less than or equal to 5 mm;
heating the glass article precursor in a sealing environment at a sealing temperature and for a time sufficient to stack seal the first glass substrate to the second glass substrate to form the glass article; wherein:
the sealing environment comprises steam, an inert gas, or combinations thereof; and
subsequent to the heating, the second interface surface of the second glass substrate and the first interface surface of the first glass substrate are in direct contact with one another, wherein the direct contact between the first glass substrate and the second glass substrate establishes an interface between the first glass substrate and the second glass substrate;
wherein the glass article satisfies at least one of (1) or (2) below:
(1) at least one of a peak-to-valley difference of a hydroxyl group concentration measured along a first line, a peak-to-valley difference of a hydroxyl group concentration measured along a second line, or a peak-to-valley difference of a hydroxyl group concentration measured along a third line is less than or equal to 30 ppm; or
(2) a birefringence of the glass article, as measured at the interface, is less than or equal to 50 nm/cm, less than or equal to 20 nm/cm, or less than or equal to 10 nm/cm;
wherein:
the first line is perpendicular to the interface;
the first line extends between a depth of the first glass substrate of a first distance from the interface and the interface;
the hydroxyl group concentration is measured along the first line at a spacing of less than or equal to 0.1 mm;
the second line is perpendicular to the interface;
the second line extends between a depth of the second glass substrate of a second distance from the interface and the interface;
the hydroxyl group concentration is measured along the second line at a spacing of less than or equal to 0.1 mm;
the third line is perpendicular to the interface;
the third line extends between the depth of the first glass substrate of the first distance from the interface and the depth of the second glass substrate of the second distance from the interface; and
the hydroxyl group concentration is measured along the third line at a spacing of less than or equal to 0.1 mm.

2. The method of claim 1, wherein the first interface surface and the second interface surface are spaced apart by a distance greater than 0 mm and less than or equal to 3 mm or greater than or equal to 0.5 mm and less than or equal to 1.5 mm.

3. The method of claim 1, wherein the heating comprises at least one of (i) or (ii):
(i) maintaining the glass article precursor at the sealing temperature of from greater than or equal to 500° C. to less than or equal to 2,000° C.; or
(ii) exposing the glass article precursor to the sealing environment at the sealing temperature for a time of greater than or equal to 0.5 hour to less than or equal to 48 hours.

4. The method of claim 1, wherein the heating comprises increasing a temperature of the glass article precursor to the sealing temperature at a temperature ramping rate for a first duration of time, maintaining the glass article precursor at the sealing temperature for a second duration of time, and decreasing the temperature of the glass article precursor at a cooling rate for a third duration of time, wherein the temperature ramping rate is from 10° C. per hour to 1,000° C. per hour for the first duration of time; and wherein the cooling rate is from 30° C. per hour to 1,000° C. per hour for the third duration of time.

5. The method of claim 1, wherein the heating comprises increasing a temperature of the glass article precursor to a first hold temperature, maintaining the glass article precursor at the first hold temperature for a first hold time, increasing the temperature of the glass article precursor to the sealing temperature, maintaining the glass article precursor at the sealing temperature for a second hold time, and decreasing the temperature of the glass article precursor.

6. The method of claim 1, wherein the heating comprises:
introducing steam to the sealing environment to achieve a partial pressure of steam within the sealing environment of from greater than or equal to 0 kilopascals (kPa) to less than or equal to 1,000 kPa;
exposing the glass article precursor to the sealing environment; and
laser treating the glass article precursor.

7. The method of claim 1, wherein the laser treating satisfies at least one of 7 or (iv):
(iii) the laser treating increases at least a portion of the first glass substrate and a portion of the second glass substrate to a temperature of greater than or equal to 1,400° C., greater than or equal to 1,600° C., greater than or equal to 1,800° C., or greater than or equal to 2,000° C.; or
(iv) the laser treating is operated for a time of less than or equal to 20 seconds.

8. The method of claim 1, wherein the sealing environment comprises at least one of:
greater than or equal to 5 volume percent (vol. %), greater than or equal to 10 vol. %, greater than or equal to 25 vol. %, greater than or equal to 50 vol. %, greater than or equal to 60 vol. %, greater than or equal to 70 vol. %, greater than or equal to 80 vol. %, greater than or equal to 90 vol. %, greater than or equal to 95 vol. %, greater than or equal to 99 vol. %, or 100 vol. % steam, based on a total volume of gases in the sealing environment; or
a partial pressure of oxygen of from greater than or equal to 1.0 kilopascals (kPa) to less than or equal to 100 kPa.

9. The method of claim 1, further comprising, during heating maintaining a constant partial pressure of steam in the sealing environment and adjusting a temperature profile of the heating to maintain the absolute value of the difference of the hydroxyl group concentration at the interface and the hydroxyl group concentration at a depth of the first glass substrate of the first distance from the interface less than or equal to 30 ppm;
wherein adjusting a temperature profile of the heating comprises adjusting one or more of the sealing temperature, a temperature ramping rate, a duration of maintaining the glass article precursor at the sealing temperature, a cooling rate, or combinations of these.

10. The method of claim 1, further comprising, during heating, adjusting a partial pressure of steam in the sealing environment to maintain the absolute value of the difference of the hydroxyl group concentration at the interface and the hydroxyl group concentration at a depth of the first glass substrate of the first distance from the interface less than or equal to 30 ppm;
wherein adjusting the partial pressure of steam in the sealing environment comprises increasing or decreasing a flow rate of steam into the sealing environment.

11. A glass article comprising a first glass substrate and a second glass substrate stack sealed to the first glass substrate at an interface, wherein at least one of a peak-to-valley difference of a hydroxyl group concentration measured along a first line, a peak-to-valley difference of a hydroxyl group concentration measured along a second line, or a peak-to-valley difference of a hydroxyl group concentration measured along a third line is less than or equal to 30 ppm;
wherein:
the first line is perpendicular to the interface;
the first line extends between a depth of the first glass substrate of a first distance from the interface and the interface;
the hydroxyl group concentration is measured along the first line at a spacing of less than or equal to 0.1 mm;
the second line is perpendicular to the interface;
the second line extends between a depth of the second glass substrate of a second distance from the interface and the interface;
the hydroxyl group concentration is measured along the second line at a spacing of less than or equal to 0.1 mm;
the third line is perpendicular to the interface;
the third line extends between the depth of the first glass substrate of the first distance from the interface and the depth of the second glass substrate of the second distance from the interface; and
the hydroxyl group concentration is measured along the third line at a spacing of less than or equal to 0.1 mm.

12. The glass article of claim 11, wherein the glass article further satisfies at least one of (a), (b), (c), (d), (e), or (f) below:
(i) the hydroxyl group concentration at the interface is greater than 0 ppm and less than or equal to 1,500 ppm, or greater than or equal to 1,000 ppm and less than or equal to 1,400 ppm;
(ii) the hydroxyl group concentration at the interface is greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm;
(iii) the hydroxyl group concentration at the depth of the first glass substrate of the first distance from the interface is greater than 0 ppm and less than or equal to 1,500 ppm, or greater than or equal to 1,000 ppm and less than or equal to 1,400 ppm;
(iv) the hydroxyl group concentration at the depth of the first glass substrate of the first distance from the interface is greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm;
(v) the hydroxyl group concentration at the depth of the second glass substrate of the second distance from the interface is greater than 0 ppm and less than or equal to 1,500 ppm, or greater than or equal to 1,000 ppm and less than or equal to 1,400 ppm; or
(vi) the hydroxyl group concentration at the depth of the second glass substrate of the second distance from the interface is greater than or equal to 50 ppm, greater than or equal to 200 ppm, greater than or equal to 400 ppm, greater than or equal to 700 ppm, greater than or equal to 800 ppm, greater than or equal to 900 ppm, or greater than or equal to 1,000 ppm.

13. The glass article of claim 11, wherein at least one of the first distance or the second distance is greater than or equal to 0.5 mm and less than or equal to 5.0 mm.

14. The glass article of claim 11, wherein the glass article further satisfies at least one of (g), (h), (i), or (j) below:
(vii) the glass article has an average thickness of greater than or equal to 20 mm, greater than or equal to 50 mm, or greater than or equal to 100 mm, as measured perpendicular to the interface;
(viii) the first glass substrate has an average thickness of greater than or equal to 10 mm, greater than or equal to 25 mm, or greater than or equal to 50 mm, as measured perpendicular to the interface;
(ix) the second glass substrate has an average thickness of greater than or equal to 10 mm, greater than or equal to 25 mm, or greater than or equal to 50 mm, as measured perpendicular to the interface; or
(x) the glass article has a mass of greater than 1 kilogram, greater than 10 kilograms, or greater than 25 kilograms.

15. The glass article of claim 11, wherein at least one of a peak-to-valley difference of a titania concentration measured along a fourth line, a peak-to-valley difference of a titania concentration measured along a fifth line, or a peak-to-valley difference of a titania concentration measured along a sixth line is greater than or equal to 30 ppm;
wherein:
the fourth line is perpendicular to the interface;
the fourth line extends between a depth of the first glass substrate of a fourth distance from the interface and the interface;
the titania concentration is measured along the fourth line at a spacing of less than or equal to 0.1 mm;
the fifth line is perpendicular to the interface;
the fifth line extends between a depth of the second glass substrate of a fifth distance from the interface and the interface;
the titania concentration is measured along the fifth line at a spacing of less than or equal to 0.1 mm;
the sixth line is perpendicular to the interface;
the sixth line extends between the depth of the first glass substrate of the fourth distance from the interface and the depth of the second glass substrate of the fifth distance from the interface; and
the titania concentration is measured along the sixth line at a spacing of less than or equal to 0.1 mm;
wherein the glass article further satisfies at least one of (k), (1), (m), (n), or (o) below:
(xi) the at least one of the peak-to-valley difference of the titania concentration measured along the fourth line, the peak-to-valley difference of the titania concentration measured along the fifth line, or the peak-to-valley difference of the titania concentration measured along the sixth line is less than or equal to 700 ppm, less than or equal to 400 ppm, or less than or equal to 200 ppm;
(xii) an absolute value of a difference of an average titania concentration at the interface and an average titania concentration at the depth of the first glass substrate of the fourth distance from the interface is greater than or equal to 30 ppm;
(xiii) the absolute value of the difference of the average titania concentration at the interface and the average titania concentration at the depth of the first glass substrate of the fourth distance from the interface is less than or equal to 700 ppm, less than or equal to 400 ppm, or less than or equal to 200 ppm;
(xiv) an absolute value of a difference of an average titania concentration at the interface and an average titania concentration at the depth of the second glass substrate of the fifth distance from the interface is greater than or equal to 30 ppm; or
(xv) the absolute value of the difference of the average titania concentration at the interface and the average titania concentration at the depth of the second glass substrate of the fifth distance from the interface is less than or equal to 700 ppm, less than or equal to 400 ppm, or less than or equal to 200 ppm.

16. The glass article of claim 11, wherein at least one of a peak-to-valley difference of the CTE slope measured along a seventh line, a peak-to-valley difference of the CTE slope measured along an eighth line, or a peak-to-valley difference of the CTE slope measured along a ninth line is less than or equal to 0.1 ppb/K², as measured at 20° C.;
wherein:
the seventh line is perpendicular to the interface;
the seventh line extends between a depth of the first glass substrate of a seventh distance from the interface and the interface;
the CTE slope is measured along the seventh line at a spacing of less than or equal to 0.1 mm;
the eighth line is perpendicular to the interface;
the eighth line extends between a depth of the second glass substrate of an eighth distance from the interface and the interface;
the CTE slope is measured along the eighth line at a spacing of less than or equal to 0.1 mm;
the ninth line is perpendicular to the interface;
the ninth line extends between the depth of the first glass substrate of the seventh distance from the interface and the depth of the second glass substrate of the eighth distance from the interface; and
the CTE slope is measured along the ninth line at a spacing of less than or equal to 0.1 mm;
wherein the glass article further satisfies at least one of (p), (q), or (r) below:
(xvi) wherein an absolute value of a difference of the CTE slope at the interface and the CTE slope at the depth of the first glass substrate of the seventh distance from the interface is less than or equal to 0.1 ppb/K², as measured at 20° C.;
(xvii) an absolute value of a difference of the CTE slope at the interface and the CTE slope at the depth of the second glass substrate of the eighth distance from the interface is less than or equal to 0.1 ppb/K², as measured at 20° C.; or
(xviii) an absolute value of a difference of the CTE slope at the depth of the first glass substrate of the seventh distance from the interface and the CTE slope at the depth of the second glass substrate of the eighth distance from the interface is less than or equal to 0.1 ppb/K², as measured at 20° C.

17. The glass article of claim 11, wherein at least one of a peak-to-valley expansivity slope measured along a tenth line, a peak-to-valley expansivity slope measured along an eleventh line, or a peak-to-valley expansivity slope measured along a twelfth line is less than or equal to 2.0 ppb/K², less than or equal to 1.0 ppb/K², or less than or equal to 0.5 ppb/K², as measured at 20° C.;
wherein:
the tenth line is perpendicular to the interface;
the tenth line extends between a depth of the first glass substrate of a tenth distance from the interface and the interface;
the expansivity slope is measured along the tenth line at a spacing of less than or equal to 0.1 mm;
the eleventh line is perpendicular to the interface;
the eleventh line extends between a depth of the second glass substrate of an eleventh distance from the interface and the interface;
the expansivity slope is measured along the eleventh line at a spacing of less than or equal to 0.1 mm;
the twelfth line is perpendicular to the interface;
the twelfth line extends between the depth of the first glass substrate of the tenth distance from the interface and the depth of the second glass substrate of the eleventh distance from the interface; and
the expansivity slope is measured along the twelfth line at a spacing of less than or equal to 0.1 mm;
wherein the glass article further satisfies at least one of(s), (t), (u), (v), (w), or (x) below:
(xix) an absolute value of a difference of the expansivity slope at the interface and the expansivity slope at the depth of the first glass substrate of the tenth distance from the interface is less than or equal to 2.0 ppb/K², less than or equal to 1.0 ppb/K², or less than or equal to 0.5 ppb/K², as measured at 20° C.;
(xx) the absolute value of the difference of the expansivity slope at the interface and the expansivity slope at the depth of the first glass substrate of the tenth distance from the interface is greater than or equal to 0.01 ppb/K², as measured at 20° C.;
(xxi) an absolute value of a difference of the expansivity slope at the interface and the expansivity slope at the depth of the second glass substrate of the eleventh distance from the interface is less than or equal to 2.0 ppb/K², less than or equal to 1.0 ppb/K², or less than or equal to 0.5 ppb/K², as measured at 20° C.;
(xxii) the absolute value of the difference of the expansivity slope at the interface and the expansivity at the depth of the second glass substrate of the eleventh distance from the interface is greater than or equal to 0.01 ppb/K², as measured at 20° C.;
(xxiii) an absolute value of a difference of the expansivity slope at the depth of the first glass substrate of the tenth distance from the interface and the expansivity slope at the depth of the second glass substrate of the eleventh distance from the interface is less than or equal to 2.0 ppb/K², less than or equal to 1.0 ppb/K², or less than or equal to 0.5 ppb/K², as measured at 20° C.; or
(xxiv) the absolute value of the difference of the expansivity slope at the depth of the first glass substrate of the tenth distance from the interface and the expansivity slope at the depth of the second glass substrate of the eleventh distance from the interface is greater than or equal to 0.01 ppb/K², as measured at 20° C.

18. The glass article of claim 11, wherein at least one of a birefringence of the glass article as measured along a thirteenth line, a birefringence of the glass article as measured along a fourteenth line, or a birefringence of the glass article as measured along a fifteenth line is less than or equal to 50 nm/cm, less than or equal to 20 nm/cm, or less than or equal to 10 nm/cm;
wherein:
the thirteenth line is perpendicular to the interface and extends between a depth of the first glass substrate of a thirteenth distance from the interface and the interface;
the birefringence is measured along the thirteenth line at a spacing of less than or equal to 0.1 mm;
the fourteenth line is perpendicular to the interface and extends between a depth of the second glass substrate of a fourteenth distance from the interface and the interface;
the birefringence is measured along the fourteenth line at a spacing of less than or equal to 0.1 mm;
the fifteenth line is perpendicular to the interface and extends between the depth of the first glass substrate of the thirteenth distance from the interface and the depth of the second glass substrate of the fourteenth distance from the interface; and
the birefringence is measured along the fifteenth line at a spacing of less than or equal to 0.1 mm.

19. A glass article comprising a first glass substrate and a second glass substrate stack sealed to the first glass substrate at an interface, wherein a birefringence of the glass article, as measured at the interface, is less than or equal to 50 nm/cm, less than or equal to 20 nm/cm, or less than or equal to 10 nm/cm.

20. The glass article of claim 19, wherein at least one of a peak-to-valley difference of a hydroxyl group concentration measured along a first line, a peak-to-valley difference of a hydroxyl group concentration measured along a second line, or a peak-to-valley difference of a hydroxyl group concentration measured along a third line is less than or equal to 30 ppm;
wherein:
the first line is perpendicular to the interface;
the first line extends between a depth of the first glass substrate of a first distance from the interface and the interface;
the hydroxyl group concentration is measured along the first line at a spacing of less than or equal to 0.1 mm;
the second line is perpendicular to the interface;
the second line extends between a depth of the second glass substrate of a second distance from the interface and the interface;
the hydroxyl group concentration is measured along the second line at a spacing of less than or equal to 0.1 mm;
the third line is perpendicular to the interface;
the third line extends between the depth of the first glass substrate of the first distance from the interface and the depth of the second glass substrate of the second distance from the interface; and
the hydroxyl group concentration is measured along the third line at a spacing of less than or equal to 0.1 mm.
